(19) United States
(12) Patent Application Publication
(10) Pub. No.: US 2017/0316380 A1
(43) Pub. Date: Nov. 2, 2017

(54) PROFILE ENRICHMENT

(71) Applicant: CEB Inc., Arlington, VA (US)

(72) Inventors: Vijayakumar Swaminathan, The Woodlands, TX (US); Vamsee Kumar Tirukkala, The Woodlands, TX (US)

(21) Appl. No.: 15/496,245

(22) Filed: Apr. 25, 2017

Related U.S. Application Data
(60) Provisional application No. 62/329,228, filed on Apr. 29, 2016.

(51) Int. Cl. G06Q 10/10

(52) U.S. Cl. CPC G06Q 10/105

(57) ABSTRACT

Methods, systems, and apparatus for accessing profile data comprising employee profiles that correspond to different employees, each employee profile including one or more attributes of the corresponding employee that were determined from publicly available Internet data describing the corresponding employee. From a first profile of the employee profiles, a first attribute that is included in the first profile is identified. Second profiles are selected that each include the first attribute and that each correspond to a different employee from the employee that corresponds to the first profile. From the second profiles, a second attribute is identified that is included in at least some of the second profiles. A confidence score is generated for the second attribute based at least on a number of the second profiles that specify the second attribute. Based on determining that the confidence score satisfies a threshold, the second attribute is added to the first profile.

### CLAIM OF PRIORITY

This application claims priority under 35 USC §119(e) to U.S. Patent Application Ser. No. 62/329,228, filed on Apr. 29, 2016, the entire contents of which are hereby incorporated by reference.

### TECHNICAL FIELD

This specification relates generally to generating and enhancing records indicating workforce characteristics.

### BACKGROUND

Users often provide information to Internet resources or Internet-based services that relates to their personal or professional lives. Such information may be accessible by other users at the resources or via the Internet-based services and may provide insight into the educational or professional background or competencies of the users.

### SUMMARY

In some implementations, a workforce analysis system locates information associated with employees in different geographical areas, and processes the information to determine characteristics of the workforce or job market in those geographical areas. To generate information indicating demographics and other characteristics, the workforce analysis system can locate information associated with individual workers in one or more resources, such as one or more websites, social networks, items of audio or video content, Internet postings, or other digital media. Employee profiles, each specific to an individual employee, are generated based on processing the located information. The workforce analysis system then processes the information included in the employee profiles using one or more analytical models to generate information that indicates, for example, current characteristics, projected future characteristics, or trends relating to the workforce or job market of different industries or jobs in various geographical areas. In some instances, the workforce analysis system can generate specific demographic information in response to user-submitted queries, for example, queries that request information about the workforce or job market in particular geographical areas with respect to particular industries or fields.

Generating an employee profile for a particular employee can involve aggregating information from different resources that are determined to relate to the particular employee. The employee profile can also be enriched by making additional inferences about the employee beyond what is indicated in the accessed information that relates to the particular employee. For example, the information that relates to the particular employee can be processed in conjunction with information about other employees that may be identified as being similar to the particular employee. For example, the workforce analysis system may augment the employee profile of the particular employee with information that is inferred based on shared characteristics of the particular employee and other employees. For example, although the skills of the particular employee may not be explicitly indicated in any available documents, the skills of other employees having comparable education, job roles, and experience levels may be imputed to the particular employee when appropriate criteria are satisfied. Inferred skills or other attributes can be added to an employee's profile. In some instances, certain characteristics of an employee are inferred when the employee is determined to share one or more characteristics with another employee profile, and inferring information based on the determination.

The workforce analysis system can utilize these methods to generate employee profiles for a multiplicity of employees. Using these employee profiles, the workforce analysis system can generate information that indicates various characteristics, such as demographics of particular workforces or job markets in particular geographic locations. The generated information can be provided to end users to assist with human resources development and business decisions.

Innovative aspects of the subject matter described in this specification may be embodied in methods that include the actions of: accessing profile data comprising employee profiles that each correspond to a different employee, each employee profile including one or more attributes of the corresponding employee that were determined from publicly available Internet data describing the corresponding employee; identifying, from a first profile of the employee profiles, a first attribute that is included in the first profile, the first profile corresponding to a particular employee; selecting, from among the employee profiles, second profiles that each include the first attribute and correspond to an employee other than the particular employee; identifying, from the second profiles, a second attribute that is included in at least some of the second profiles, wherein the second attribute is different from the first attribute and is not included in the first profile; generating a confidence score for the second attribute based at least in part on a number of the second profiles that specify the second attribute; determining that the confidence score for the second attribute satisfies a threshold; and adding the second attribute to the first profile based at least on determining that the confidence score determined for the second attribute satisfies the threshold.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

In some implementations, aspects of the subject matter described in this specification may be embodied in methods, systems, and computer programs for performing the actions of: accessing a taxonomy of attributes that includes the first attribute; determining that a third attribute is indicated as being related to the first attribute in the taxonomy, wherein the third attribute is different from the first attribute and is not included in the first profile; and adding the third attribute to the first profile in response to determining that the third attribute is indicated as being related to the first attribute in the taxonomy. In some implementations, the taxonomy is a hierarchical taxonomy, and wherein determining that the third attribute is indicated as being related to the first attribute in the taxonomy comprises determining that the third attribute is inferior to the first attribute in the hierarchical taxonomy.

Aspects of the subject matter described in this specification may include methods, systems, and computer programs for: accessing, at a publicly available resource that is accessible over the Internet, information that (i) identifies one or more attributes included in the first profile, and that (ii) does not identify the particular employee; identifying a third attribute included in the resource, wherein the third attribute is different from the first attribute and is not included in the first profile; and adding the third attribute to the first profile. In some implementations, each of the employee profiles is assigned a robustness score, and selecting the second profiles comprises selecting one or more profiles that include the first attribute and that are each assigned a robustness score that satisfies a second threshold.

Aspects of the subject matter described in this specification may include methods, systems, and computer programs for: selecting, after a period of time and from among the employee profiles, third profiles that each include the first attribute and correspond to an employee other than the particular employee; identifying, from the third profiles, a third attribute that is included in at least some of the third profiles, wherein the third attribute is different from the first attribute and the second attribute and is not included in the first profile; generating a confidence score for the third attribute based at least in part on a number of the third profiles that specify the third attribute; determining that the confidence score for the third attribute satisfies a second threshold; and adding the second attribute to the first profile based at least on determining that the confidence score determined for the third attribute satisfies the second threshold.

Aspects of the subject matter described in this specification may include methods, systems, and computer programs for: accessing synonym data indicates sets of attributes that are synonymous with one another, each set of attributes including one or more attributes that are synonymous with one another; identifying, from the synonym data, a set of attributes that includes the first attribute; identifying a third attribute that is included in the set of attributes that includes the first attribute, wherein the third attribute is different from the first attribute; and adding the third attribute to the first profile. In some implementations, each of the employee profiles is assigned a robustness score, and selecting the second profiles comprises selecting one or more profiles that include the first attribute and that are each assigned a robustness score that satisfies a second threshold.

Aspects of the subject matter described in this specification may include methods, systems, and computer programs for: selecting, after a period of time and from among the employee profiles, third profiles that each include the first attribute and correspond to an employee other than the particular employee; identifying, from the third profiles, a third attribute that is included in at least some of the third profiles, wherein the third attribute is different from the first attribute and the second attribute and is not included in the first profile; generating a confidence score for the third attribute based at least in part on a number of the third profiles that specify the third attribute; determining that the confidence score for the third attribute satisfies a second threshold; and adding the second attribute to the first profile based at least on determining that the confidence score determined for the third attribute satisfies the second threshold.

Aspects of the subject matter described in this specification may include methods, systems, and computer programs for: accessing synonym data indicates sets of attributes that are synonymous with one another, each set of attributes including one or more attributes that are synonymous with one another; identifying, from the synonym data, a set of attributes that includes the first attribute; identifying a third attribute that is included in the set of attributes that includes the first attribute, wherein the third attribute is different from the first attribute; and adding the third attribute to the first profile. In some implementations, selecting the second profiles further comprises: identifying a geographical area that is indicated by the first profile, wherein the geographical area corresponds to a work location or location of residence of the particular employee; and identifying, as the second profiles, one or more profiles that each include the first attribute, correspond to an employee other than the particular employee, and indicate the geographical area. In some implementations, the confidence score for the second attribute is based at least in part on a proportion of the second profiles that specify the second attribute. In some implementations, the confidence score for the second attribute is based at least in part on one or more similarity measures, each of the one or more similarity measures indicating a degree of similarity between the first profile and a particular profile included in the second profiles.

Innovative aspects of the subject matter described in this specification may also be embodied in other methods, systems, and computer programs. In some implementations, a system may comprise: a plurality of harvester modules configured to access information included in resources that are publicly available over the Internet; an aggregator subsystem configured to: identify attributes of employees including skills of the employees, the attributes being specified in the resources; determine individual employees related to the resources; and add, to employee profiles that each correspond to a different employee, the attributes identified from the resources, wherein each attribute added to an employee profile is identified from a resource that is determined to be related to an employee that corresponds to the employee profile; an attribute inferring engine configured to: access the employee profiles; identify, from a first profile of the employee profiles, a first attribute that is included in the first profile, the first profile corresponding to a particular employee; select, from among the employee profiles, second profiles that each include the first attribute and correspond to an employee other than the particular employee; identify, from the second profiles, a second attribute that is included in at least some of the second profiles, wherein the second attribute is different from the first attribute and is not included in the first profile; generate a confidence score for the second attribute based in part on a number of the second profiles that specify the second attribute; determine that the confidence score for the second attribute satisfies a threshold; and add the second attribute to the first profile based at least on determining that the confidence score determined for the second attribute satisfies the threshold; and an analyzer subsystem that is configured to determine characteristics of subsets of employees in different geographical areas based on performing an analysis of the skills included in the employee profiles.

Other embodiments of these aspects include corresponding computer-implemented methods or computer programs configured to perform the actions of the system. For instance, one or more computers may be configured to perform a method corresponding to the actions of the system, or one or more computer programs may be configured with instructions that, when executed by data processing apparatus, cause the apparatus to perform the actions of the system.

In some implementations, aspects of the subject matter described in this specification may be embodied in systems comprising: a communication subsystem configured to: receive a query; and in response to receiving the query: provide one or more parameters to the analyzer subsystem, wherein at least some of the one or more parameters are determined based on the query; receive data from the analyzer subsystem; and provide the data received from the analyzer subsystem for output. Other embodiments of these aspects include corresponding computer-implemented methods or computer programs configured to perform the actions of the system.

In some implementations, aspects of the subject matter described in this specification may be embodied in systems wherein: the analyzer subsystem is further configured to: identify, for each of multiple different geographical locations, a subset of employee profiles that each correspond to the geographical location and have a particular set of skills specified by the query; determine, by analyzing each subset of the employee profiles, characteristics of a segment of the workforce having the particular set of skills for each of the different geographical locations; and providing the determined characteristics to the communication subsystem; wherein, to provide the data received from the analyzer subsystem for output, the communication subsystem is configured to provide, over a computer network for display at a client device, the information indicating the determined characteristics of the segment of the workforce having the particular set of skills for each of the different geographical locations. In some implementations, the aggregator subsystem is further configured to: determine that the employee profiles do not include an employee profile corresponding to an employee related a particular resource included among the resources; in response to the determination, generate a new employee profile corresponding to the employee; and add, to the new employee profile, the attributes identified from the particular resource. Other embodiments of these aspects include corresponding computer-implemented methods or computer programs configured to perform the actions of the system.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is an example user interface that includes job market demographics determined by a workforce analysis system.

FIG. 2 depicts an example of a workforce analysis system.

FIG. 3 depicts an example implementation for generating an employee profile performed by a workforce analysis system.

FIG. 4 depicts an example implementation for profile enrichment performed by a workforce analysis system.

FIG. 5 illustrates an example process for enriching employee profiles.

Like reference symbols in the various drawings indicate like elements.

### DETAILED DESCRIPTION

In some implementations, a workforce analysis system locates information associated with employees of various professions in different geographical areas, and processes the information to determine workforce and/or job market characteristics for the geographical areas. As used in this specification, an employee can refer to any worker, whether currently employed or unemployed, or whether the worker has employee status, is an independent contractor, or is self-employed. Workforce characteristics indicate characteristics relating to the active body of available employees (e.g., the total workforce including those already employed as well as those not currently employed), while job market characteristics may indicate characteristics relating to new or available job opportunities (e.g., job positions that may exist but that may not have been filled). As used herein, demographics refer to any measures of the composition or socioeconomic characteristics of groups of people, including, for example, salary, education level, skills, occupation, job roles, and so on.

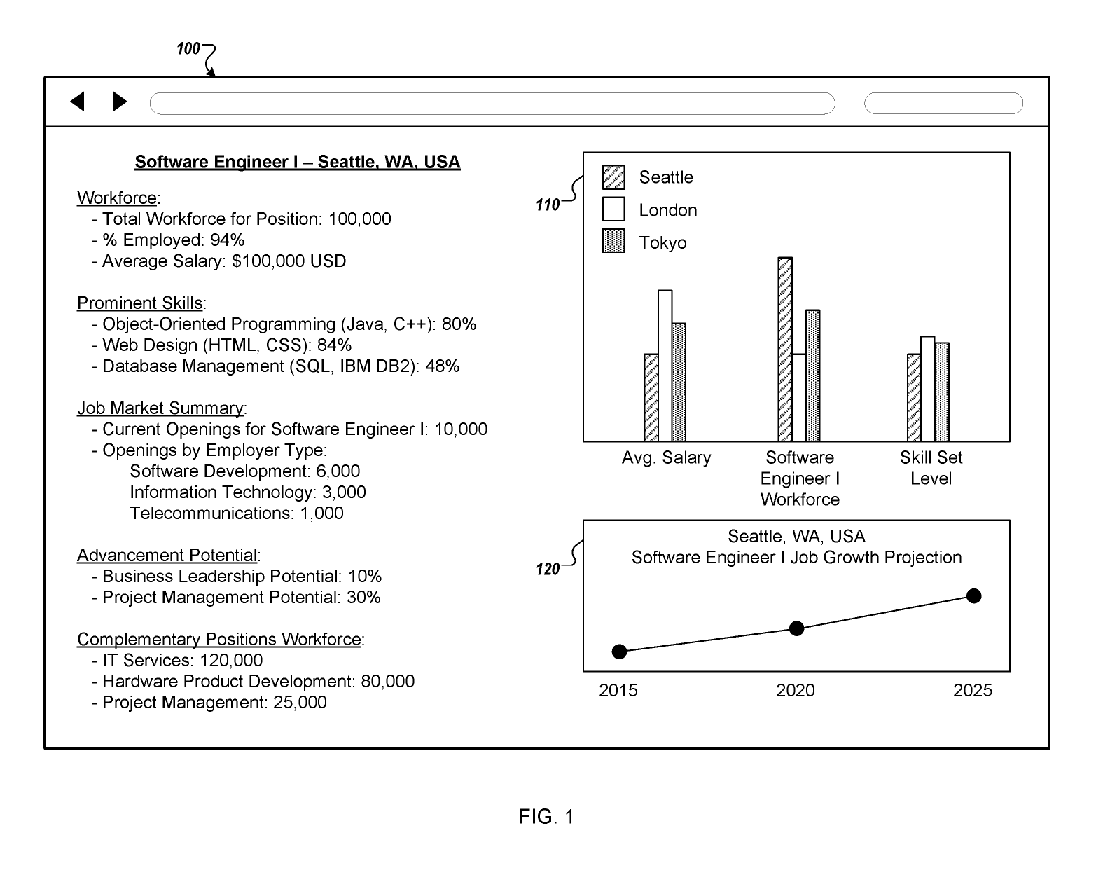

FIG. 1 illustrates an example of an interface 100 that presents workforce or job market characteristics generated by a workforce analysis system. In some implementations, the interface 100 may be presented to an end user who has submitted a query to the workforce analysis system. For example, an end user can specify various query parameters to be used by the workforce analysis system in generating workforce or job market demographics for presentation at the interface 100. Such parameters may include, for instance, particular industries, geographical locations, specific job positions, employee experience levels or roles in specific job positions, particular skills or skill sets, particular employee ages, particular education levels or educational requirements, particular certifications or professional licenses, particular compensation ranges or compensation structures, including employee benefits, or other parameters that may be relevant to developing workforce or job market demographic information for one or more geographical areas. By specifying a combination of these parameters, the user can designate a specific subset of employees about which information is desired, for example, licensed nurses in California with at least five years of experience.

In response to receiving the query including the various user-submitted parameters, the workforce analysis system can process information it maintains related to employees in various geographical areas to generate information relevant to the query. In some implementations, the workforce analysis system generates the demographic information by accessing a database of employee profiles that each include information corresponding to a particular employee. For example, the system may identify individuals that form a particular segment of the workforce indicated by the query, and the system can use the profiles for the identified individuals to generate information about that segment. Some of the information generated may include, for example, how many employees match the parameters of the query and typical or average characteristics of those employees, such as salaries, skills, job roles, and other characteristics. The information can include demographic information that indicates statistical measures of different populations or subsets of employees from one or more geographical areas. The workforce analysis system then presents the generated information at the interface 100.

As an example, an end user may submit a query to the workforce analysis system, where the query requests job market information for software engineer I positions (i.e., junior-level software engineering positions) in Seattle, USA, London, UK, and Tokyo, Japan. In response to receiving the query, the workforce analysis system can query a database of employee profiles. Each employee profile may include information that indicates characteristics of a particular employee. For example, an employee profile associated with a particular employee may include information indicating the employee's location, industry, current position, experience level, age, skills or abilities, areas of expertise, educational background, job experience, or other information relevant to the particular employee's professional capabilities or the employee's role in the work force of a particular geographical area. By querying the database of employee profiles, the workforce analysis system can locate a multiplicity of employee profiles that are pertinent to the query. For example, the workforce analysis system can identify all of the employee profiles that specify a location of either Seattle, London, or Tokyo, and that are associated with the software industry and/or that specify the employee has an entry-level software engineer position.

The workforce analysis system can process the identified employee profiles to generate demographic information responsive to the query. The workforce analysis system outputs the demographic information, or a subset of the demographic information, at the interface 100. For example, in response to the query requesting demographic information for software engineer I positions in the geographic areas of Seattle, London, and Tokyo, the workforce analysis system can output various types of demographic information at the interface 100 that are responsive to that query.

For example, as shown in FIG. 1, the workforce analysis system can present an interface 100 that displays workforce and job market demographic information for Seattle, as well as information in the graph 110 that compares workforce and job market demographic information of Seattle with that of London and Tokyo. Specifically, as shown in the interface 100, the demographic information for software engineer I positions in Seattle includes high-level or aggregate information concerning the employees classified as “software engineer I” employees in Seattle, such as information indicating that the total workforce for this position is approximately 100,000 employees, that the percentage of those 100,000 employees who are employed is 94%, and that the average salary of those 100,000 employees is $100,000 USD. The interface 100 also indicates prominent skills of those 100,000 employees, including object-oriented programming skills (e.g., Java, C++), web design skills (e.g., HTML, CSS), and database management skills (e.g., experience with SQL, IBM DB2), as well as the approximate percentage of the 100,000 employees who have each of these skills, namely 80%, 84%, and 48%, respectively. The interface 100 also provides a summary of the job market in Seattle, including information indicating that the estimated number of current software engineer I job openings is approximately 10,000, and that the concentration of this position by specific employer type is approximately 6,000 for software development employers, approximately 3,000 for information technology employers, and approximately 1,000 for telecommunications employers.

The interface 100 also includes information relating to the advancement potential of the approximate 100,000 software engineer I employees in the Seattle area. Such information may be determined by the workforce analysis system by processing the multiplicity of employee profiles that are associated with employees who are identified as residing in the Seattle areas and that hold a software engineer I position, to determine characteristics or patterns of characteristics that are regarded by the workforce analysis system as being indicative of employee advancement potential. Based on analyzing the multiplicity of employee profiles, as shown in the interface 100, the workforce analysis system has determined that 10% of the approximate 100,000 employees have business leadership potential, and that 30% of the approximate 100,000 employees have project management potential.

The interface 100 also displays approximate numbers of employees in complementary positions or complementary industries or fields of industry to the software engineer I position specified by the query. For example, the workforce analysis system may identify one or more other positions that are considered to be complementary to the software engineering industry, software engineering employers, or software engineer I positions, such as IT services positions, hardware product development positions, and project management positions. The workforce analysis system may approximate a number of employees in the workforce for each of these positions. For example, the workforce analysis system may identify the number of employee profiles that specify both residence in Seattle and that are associated with IT services positions, and based on this information may estimate the workforce of IT services employees in the Seattle area to be 120,000. Using similar techniques, the workforce analysis system may estimate the number of hardware product development employees in the Seattle area to be 80,000, and estimate the number of project management employees in the Seattle area to be 25,000.

In addition to the information that the workforce analysis system provides for output at the interface 100 that is specific to the Seattle workforce and job market for software engineer I positions, the interface 100 also includes other information, such as the graph 110, that indicates relationships between the workforce or job market of software engineer I positions in Seattle with that of other geographical areas specified by the query, such as those of London and Tokyo. The interface 100 also includes prospective information indicating expected changes in the workforce or job market for software engineer I positions in Seattle over time.

For example, the graph 110 includes comparisons of three factors relating to the workforce or job market of software engineer I employees in Seattle, London, and Tokyo. The graph 110 indicates that the average salary of employees in software engineer I positions is the lowest in Seattle, higher in Tokyo, and the highest in London. The graph 110 can also indicate that the workforce of employees in software engineer I positions is the lowest in London, higher in Tokyo, and the highest in Seattle. Lastly, the graph 110 indicates that the average skill set level of software engineer I employees is the lowest in Seattle, slightly higher in Tokyo, and the highest in London. In this instance, the average skill set level displayed in the graph 110 may be determined by the workforce analysis system based on a combination of factors, e.g., a combination of the average number of skills of the employees, educational backgrounds of the employees, and/or areas of expertise of the employees. Alternatively, the skill set level may be a metric that is defined by an outside entity, such as an industry standard or a user-defined metric, e.g., a metric that is determined based on skills that an end user submitting the query is particularly interested in new employees having.

The graph 120 may indicate prospective information relating to the submitted query. Specifically, the graph 120 indicates that the workforce of employees holding software engineer I positions in Seattle is expected to increase over the ten-year period from 2015 to 2025. The expectations may be based on a combination of factors and information. For example, the expectations may be based at least in part on information that is maintained by the workforce analysis system or derived from information maintained by the workforce analysis system, for example, based on tracking, over time, the change in the number of employee profiles that specify residence in Seattle and that also indicate a software engineer I employee position, and estimating future expectations based on those trends. Additionally or alternatively, the workforce analysis system may consider information that is external to the workforce analysis system in making such estimations. For example, the workforce analysis system may access information that indicates the known size of the software engineer I workforce for a past year (e.g., based on census data, company records, or other data). The workforce analysis system may estimate future trends in the workforce or job market of software engineer I positions in the Seattle area based on this externally-accessed information and/or based on a combination of the externally-accessed information and information that is maintained by the workforce analysis system.

While the interface 100 of FIG. 1 depicts mostly demographic information that is specific to the user-submitted query relating to software engineer I positions in the Seattle area, the workforce analysis system may also offer similar or different information for other geographic areas, such as London and Tokyo. Moreover, the demographic information shown in the interface 100 of FIG. 1 is only exemplary, and additional or different information may also be displayed at the interface 100, such as other information indicating education, compensation, experience, skill, expertise, growth potential, interests, or other information specific to the software engineer I workforce or job market in various geographical areas. The information may also include other information pertinent to human resources management in particular geographical areas, such as information indicating competitors or information relating to the workforce employed by those competitors, information indicating workforce or job market characteristics, e.g., ages, language competencies, cultural diversity, or other characteristics of an area's workforce, information indicating major industries or focus points for the workforce of an area, information indicating changes in population, education level, compensation, cost of living or other relevant factors to a particular geographic area, or other information.

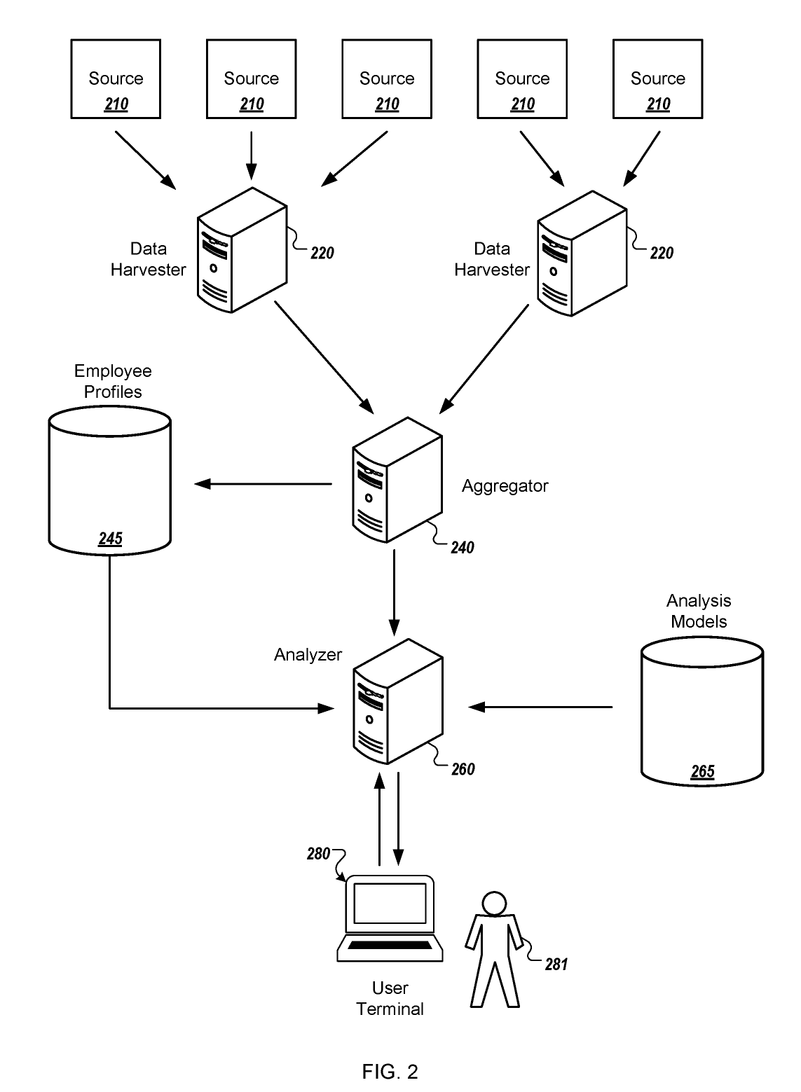

FIG. 2 illustrates an example of a workforce analysis system that is capable of providing demographic information to end users. Briefly, the workforce analysis system of FIG. 2 comprises one or more sources 210 that include or are associated with information specific to employees, and one or more data harvesters 220 that access the information included in or associated with the employees at the sources 210. In some implementations, sources 210 may include information that is not specific to individual employees, but provides generalized information and/or statistics for specific businesses, businesses or industries within a geographical region, geographical regions generally (e.g., unemployment or income statistics), etc. The workforce analysis system further includes an aggregator 240 that aggregates the information accessed by the data harvesters 220, and a multiplicity of employee profiles 245 that are each specific to a particular employee. An analyzer 260 of the workforce analysis system can analyze all or a subset of the employee profiles 245 based on one or more of a set of analysis models 265 to generate demographic information. The workforce analysis system can provide the demographic information generated by the analyzer 260 to a terminal 280 associated with an end user 281. In some examples, the demographic information generated by the analyzer 260 can be responsive to a query submitted by the end user 281 at the terminal 280.

In some implementations, the sources 210 may include resources that are accessible by the workforce analysis system over one or more wired or wireless networks. For example, the sources 210 may include one or more web pages, documents, databases, images, items of audio or video content, or other resources that are accessible over the Internet by the data harvesters 220 of the workforce analysis system. Such web pages, documents, content items, or other resources may include company web pages, social network pages, job postings, registries, or other resources that include information relating to specific employees or to specific industries or job positions held by employees. Information can be aggregated from many types of resources, including resources separate from social networks, including information about the employees that is not provided by the employees themselves. Additional examples of resources from which information may be aggregated include journal articles, news stories, white papers, professional directories, company biography pages, blogs, alumni records, and professional licensing documents (e.g., pages, lists, or databases of certifications for engineers, nurses, doctors, lawyers, financial planners, and so on). Each of the sources 210 may include information that is specific to a particular employee, to a group of specific employees, or to a class of employees, such as a class of employees holding a certain job position or in a certain industry.

Specific examples of sources 210 of information may include GitHub or other source code repositories, Twitter or other social networking sites, labor statistics and employment repositories, e.g., as provided by the U.S. Bureau of Labor Statistics, Eurostat, or other organizations or public entities that provide information or statistics relating to labor or employment according to geographical region, the United Nations Development Program (UNDP), which provides population, employment, income, and other information and statistics by region, the United Nations Educational, Scientific, and Cultural Organization (UNESCO), which provides information and statistics relating to education, industry, and employment by geographical region, company career websites or general job posting websites, websites or databases of patents held in various jurisdictions, or other sources of information relating to individual employees, businesses, industries, or geographical regions.

Each of the one or more data harvesters 220 may be capable of accessing information included in or associated with one or more sources 210. For example, a data harvester 220 may be capable of crawling web pages, documents, or other web resources to identify information associated with employees, groups of employees, or classes of employees. In some examples, identifying information in a web page, document, or other resource may include determining that the web page, document, or other resource includes information relevant to the purposes of the workforce analysis system in generating or supplementing the employee profiles 245 and/or the analysis models 265.

Based on determining that a web page, document or other resource includes relevant information, the data harvester 220 may obtain a copy of the web page, document, or other web resource. Additionally or alternatively, the data harvester 220 may extract the relevant information from the web page, document, or other web resource. That is, the data harvester 220 may process the web page, document, or other web resource and determine the information, for example, as an information element about a particular employee, group of employees, or class of employees.

The aggregator 240 can obtain the information accessed or obtained by the one or more data harvesters 220 and can process the information to classify the information as being pertinent to a particular employee, groups of employees, or classes of employees. In some examples, the aggregator 240 may receive information from a data harvester 220, and may process the information to remove irrelevant information, or information that is not identified as being reliable. For example, the aggregator 240 may receive information from a social network profile of a particular employee that has been accessed by the data harvester 220, and may process the received information to remove certain personal information about the particular employee that is not determined to be relevant to their professional status. Such information may include information about the employee's hobbies, religious or political affiliations, entertainment preferences or favorites, images, audio, or video associated with or contained in the social network page, or other information that is not relevant to the particular employee's professional status. Similarly, the aggregator may determine that certain information is unreliable for various reasons, and may exclude the unreliable information. Additionally, the aggregator 240 may determine that the information accessed by the data harvester 220 is associated with a particular employee, for example, based on determining that the social network is associated with a user account belonging to a particular user.

In some implementations, determining that information accessed by a data harvester 220 pertains to a particular employee can involve performing a disambiguation process on the accessed information to determine with a satisfactory confidence, e.g., at least a predetermined minimum level of confidence, that the accessed information pertains to the particular employee. For instance, the aggregator 240 may receive information from a social network page that identifies a particular employee named “John Smith,” where the workforce analysis system maintains employee profiles 245 that identify more than one employee named “John Smith.” To determine which “John Smith” the information pertains to, the aggregator 240 may match other information from the social network page against the employee profiles 245 to determine the employee profile 245 that the social network page information most likely relates.

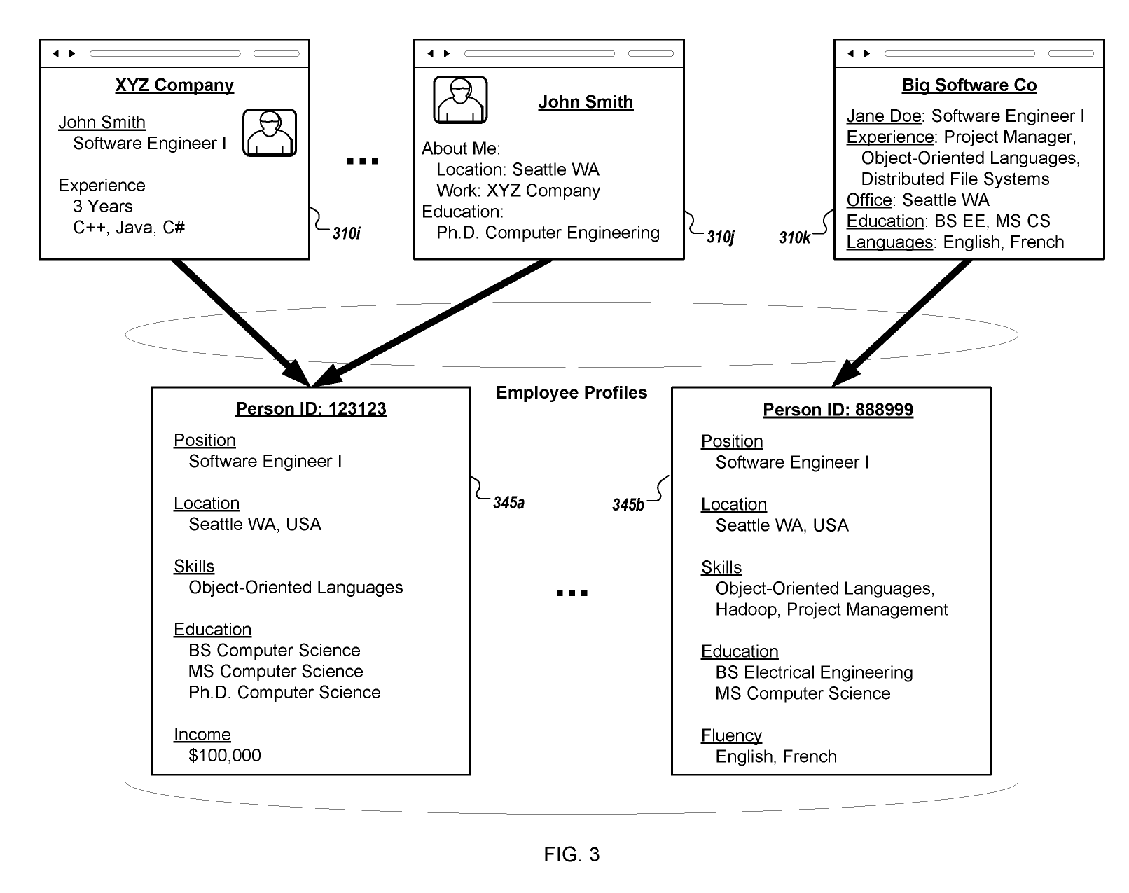

For example, the aggregator 240 may determine that information in the accessed social network page also indicates that the employee “John Smith” works as a software engineer in the Seattle area, is thirty years of age, and holds a Bachelor of Science degree (B.S.) in computer engineering. Using this information, the aggregator 240 may determine that the social network page is most likely related to a particular employee profile associated with an employee named “John Smith.” For example, the aggregator 240 may make this determination based on the particular employee profile 245 also specifying that the employee is named “John Smith,” also works as a software engineer in the Seattle area, and is thirty years old with a B.S. in computer science. Such a determination may be made, for example, based on comparing the accessed social network page information to each of the candidate employee profiles 245 or an appropriate subset of the employee profiles 245, and determining that the social network page information has the most in common with a particular candidate employee profile 245. In some instances, if accessed information is not determined to match any candidate employee profile 245 with a sufficient confidence, the aggregator 240 may determine that the accessed information should be associated with a new employee profile 245. Other methods of identifying an employee profile 245 to which accessed information relates are discussed subsequently with respect to FIG. 3.

While described predominantly with respect to particular employees, in some instances profiles may be created and enhanced for specific businesses, industries, locations, or other entities. For example, information obtained from one or more sources 210 that relates to more general labor statistics for a geographic region may be incorporated into a profile 245 for the geographic region, wherein the profile of the geographic region might include information indicating an unemployment rate in the geographic region, age, gender, or other demographics for the geographic region, occupations, industries, or employers that are prominent in the geographic region, or other information. Similar profiles 245 may be generated for specific businesses to indicate employment demographics or other information for the business, or profiles 245 may be generated that indicate employment demographics and other information for the industry.

Additionally, in some implementations the aggregator 240 may receive information submitted by an end user 281 and may perform operations on the received information to include or generate employee profiles 245 based on the received information. For example, the end user 281 may submit information at their terminal 280 that includes information for a business of the end user 281 or of employees employed by the business of the end user 281. The information submitted by the end user 281 can be received by the aggregator 240 and may be analyzed to generate or augment one or more employee profiles 245. Additionally, the aggregator 240 may perform operations on the data submitted by the end user 281 to augment or generate a profile 245 for the business of the end user 281, to augment or generate a profile 245 for a geographical area where the business of the end user 281 is located, or to augment or generate a profile 245 for an industry of the business of the end user 281 submitting the information.

The set of employee profiles 245 may be stored in a database or other data storage, where each of the multiplicity of employee profiles 245 is associated with a particular employee. Each employee profile 245 may indicate information relevant to the particular employee's professional role. As discussed, such information may include, for example, demographic information about the particular employee, such as their age, location of residence and/or work, cultural background or heritage, gender, or other information. The information may further include education information about the particular employee, such as degrees earned by the particular employee, academic areas of concentration for the particular employee, information indicating whether the particular employee has a high school diploma, whether the employee is currently enrolled or is otherwise seeking any additional degrees or academics, whether the employee has been subject to any academic or legal discipline, or other information. The information may further indicate employment information for the particular employee, such as their employment history, industries that they are or have worked in, specific positions that the particular employee holds or has held, the names of specific employers that the employee works or has worked for, compensation amounts or compensation structures, or other information. The information included in the employee profiles 245 may further include information specifying particular skills or professional certifications of the particular employee, such as information indicating professional organization memberships, certifications for certain skills or to provide certain services, security clearances, areas of technical expertise, language proficiencies, or other information. The employee profile 245 for the particular employee may further include information specifying expectations or predictions related to the particular employee, for example, information indicating the possibility of growth of the particular employee in areas of leadership, technical expertise, project management, complementary skills or expertise, or other predictive information relating to the professional development of the particular employee.

In some implementations, each of the employee profiles 245 may be configured such that the employee profiles 245 are effectively anonymous, by excluding a name, address, or other identifying information associated with any particular employee. Instead, in each employee profile 245 may be associated with an identifier information that uniquely identifies the employee profile 245 without associating the employee profile 245 with a particular individual. Additionally or alternatively, each of the employee profiles 245, or specific information included in the employee profiles 245, may be encrypted, hashed, or otherwise protected such that the information is not readily discernible or accessible beyond the workforce analysis system. In cases where only a subset of the information is obfuscated using such techniques, the hashed, encrypted, or otherwise protected information may include, for example, information that could be used to identify a particular employee profile 245 as corresponding to a particular individual. Such information may include an employee's name, residence address, telephone number, or other identifying information.

While generally described as being maintained at a database associated with the workforce analysis system, in some implementations the employee profiles 245 may be maintained such that they are accessible by the workforce analysis system using other storage methods or over one or more networks. For example, the set of employee profiles 245 may be stored at one or more servers, main frames, hard drives, or other storage media that are accessible by the workforce analysis system, including the aggregator 240 and the analyzer 260, over one or more wired or wireless connections, including one or more local or network connections.

The analysis models 265 specify data processing techniques that are used by the analyzer 260 to process the employee profiles 245 to generate demographic information. For example, the analysis models 265 can include one or more statistical, regression, finite state, probabilistic, or other models that can be utilized to perform any descriptive, exploratory, inferential, predictive, causal, or mechanistic analysis of the employee information contained in the employee profiles 245. Such analysis can be performed by the analyzer 260 to generate workforce or job market demographic information that the workforce analysis system can then output to the end user 281 at the terminal 280. In some instances, the analysis models 265 may be adjustable or capable of adapting over time, for example, based on machine learning techniques that enable the analysis models 265 to adapt based on input training data or other information. Additionally, while predominantly considered as being maintained within a database, the analysis models 265 may alternatively be maintained and accessible to the workforce analysis system at one or more other storage media. For example, the analysis models 265 may be stored at one or more servers, main frames, hard drives, or other storage media that are accessible to the workforce analysis system, such as the analyzer 260, over one or more wired or wireless connections, including local and network connections.

In some implementations, the analysis models 265 may include classification models or rules that are able to filter employee profiles 245 according to one or more requirements. The classification models or rules may enable an end user 281 to query for employees or businesses that satisfy the requirements of a classification model. For instance, a classification model may be given a specific name, e.g., “local software competitors,” and may be associated with one or more requirements that are used to filter employee profiles 245, where analysis may be performed on the filtered employee profiles 245 to generate a response to a query about local software competitors.” Requirements for a classification model or rule may include, for example, rules specifying specific companies, locations, employee roles, employee skills, education requirements, etc. The requirements may specify sources of information, such as a requirement that identified employee profiles 245 include patent information or include information provided by a particular source, such as a requirement that identified profiles 245 include information sourced from the U.S. Bureau of Labor Statistics. The requirements may specify a specific geographical region or specific topic, for example, such that identified employee profiles 245 include social network information posted from a specific geographic region or that relates to a specified topic. Requirements may specify certain types of information, for example, by requiring that identified profiles 245 include labor or employment information for a certain occupation title, geographical region, industry, etc.

The analysis models 265 or classification models or rules may be generated by the analyzer 260 or another component of the workforce analysis system, may be generated by an operator of the workforce analysis system and stored at the workforce analysis system, or may be submitted by an end user 281 of the workforce analysis system. For example, some analysis models 265 or classification models or rules may be developed by an operator of the workforce analysis system, e.g., when the workforce analysis system is operated and provided as a service to end users 281, such that queries submitted by end users 281 may be processed using the developed analysis models 265 or classification models or rules. Alternatively, an end user 281 may submit information defining an analysis model 265 or classification model or rule, and the submitted analysis model 265 or classification model or rule may be stored at the workforce analysis system. The analysis model 265 or classification model or rule may then be used by the workforce analysis system in responding to queries for one or more end users 281. For example, the submitted analysis model 265 or classification model or rule may be used in responding to queries submitted by the end user 281 who submitted the analysis model 265 or classification model or rule, or may be usable to respond to queries submitted by other end users within the same organization as the end user 281, or to respond to queries submitted by other end users 281, e.g., such that the submitted analysis model 265 or classification model or rule is effectively for public use by any end user of the workforce analysis system.

The analyzer 260 can obtain or access information included in or specified by the employee profiles 245 or analysis models 265, or received from the terminal 280, and can generate demographic information based on the accessed and/or received information. For example, the analyzer 260 can access a multiplicity of the employee profiles 245 and can process the multiplicity of the employee profiles 245 using one or more of the analysis models 265 to generate demographic information relating to the job market or workforce of one or more different geographical areas. In some examples, the analyzer 260 may identify the multiplicity of employee profiles 245 and the analysis models 265 used to process the multiplicity of employee profiles 245 based on a query submitted by the end user 281 at the terminal 280.

For example, the end user 281 using the terminal 280 may submit a query to the workforce analysis system that requests demographic information relating to the workforce and job market for software engineer I positions in the Seattle, London, and Tokyo geographical areas. The analyzer 260 can receive the query from the terminal 280, and based on the query can access employee profiles 245 to identify employee profiles 245 that are identified as relevant to the query. The analyzer 260 can further access the analysis models 265 and can identify specific analysis models 265 that are relevant to the query submitted by the end user 281. The analyzer 260 can then process the identified employee profiles 245 using the identified analysis models 265 with respect to the received query to generate demographic information related to the workforce or job market for software engineer I positions in the Seattle, London, and Tokyo geographical areas. The analyzer 260 can then present the generated demographic information to the end user 281 by transmitted the generated demographic information over one or more connections or networks to the terminal 280 for output.

In some implementations, the analysis models 265 may allow the analyzer 260 to determine and present demographic information for specific businesses, industries, or other pre-defined or user-defined groups. For example, the end user 281 may be able to submit a query to the workforce analysis system that requests demographic information related to a particular company, such as a competitor of a company of the end user 281. The analyzer 260 may be able to determine a company-level report for the particular company, for example, based on one or more analysis models 265 that are performed on employee profiles 245 of employees determined to be associated with the particular company. The analyzer 260 may allow presentation of the company-level report to the end user 281 by way of the terminal 280. Similarly, the end user 281 may submit a query for specific types of information for a particular company, location, or based on a particular keyword, and the workforce analysis system may be capable of providing a report to the end user 281 in response to the query. For instance, the end user 281 may submit a query for patent statistics for a particular company, e.g., to determine technologies the particular company is developing, may submit a query for patent statistics for a particular location, e.g., to determine the prevalence of certain types of companies in a particular location, such as a survey of the field of software development companies in a particular geographical location that are patenting software technology, may submit a query for patent statistics for particular keywords, e.g., to determine how many different companies are patenting technology related to the particular keywords, or may submit a query based on a combination of these factors. The analyzer 260 may generate a report, such as a patent-level report, based on the submitted query and using the analysis models 265, and may provide the generated report to the terminal 280. In some implementations, the end user 281 may be able to submit queries that are restricted to their own organization to obtain similar reports for their organization. For example, the end user 281 may be an administrator of an organization and may submit queries to obtain an employment report for the organization that can be used to guide business decisions or inform other members of the organization of the status of the organization as an employer. Such reports may include, for example, a schedule report relating to the human resources or employment by the company, an activity log relating to the human resources or employment by the company, a company report providing an overview of the human resources or employment of the company, or other reports.

In some implementations, the terminal 280 can be any computing device capable of communicating with the workforce analysis system. For example, the terminal 280 can be a personal or networked computing device, such as a desktop or laptop computer, mobile phone, smart phone, personal digital assistant (PDA), music player, e-book reader, tablet computer, or other stationary or portable computing device that includes one or more processors and non-transitory computer-readable storage media. The terminal 280 may be capable of storing and executing software for interacting with the workforce analysis system. In some instances, the terminal 280 may be capable of accessing the workforce analysis system over one or more wired or wireless connections, including one or more wired or wireless network connections (e.g., wireless free Internet (Wi-Fi), Ethernet, local area network (LAN), etc.). As an example, the workforce analysis system may be accessible as a web-based service, such that the terminal 280 can communicate with the workforce analysis system over a wired or wireless Internet connection to submit queries to the workforce analysis system and receive demographic information generated by the workforce analysis system.

FIG. 3 depicts an example of a method by which the workforce analysis system can generate employee profiles. For example, the data harvesters 220 or aggregator 240 of the workforce analysis system of FIG. 2 may be capable of performing the implementation of the method shown in FIG. 3 to generate employee profiles or augment existing employee profiles that are maintained by the workforce analysis system.

As shown in FIG. 3, the workforce analysis system can access information included in or associated with the sources 310i-310k. The workforce analysis system can process the accessed information, and based on processing the information can include new information in an existing or new employee profile 345a-345b. As shown in FIG. 3, each of the employee profiles 345a-345b can include information accessed from a single source 310i-310k, or can include information accessed from multiple sources 310i-310k.

For example, the data harvesters 220 of FIG. 2 can access information included in a first source 310i, that is a company web page for the employee “John Smith” of the “XYZ Company.” As described, the data harvesters 220 may access the information by crawling the company web page source 310i for the employee, or by otherwise detecting the information included in or associated with the company web page. The accessed information can include an image of the employee “John Smith,” can indicate that the employee's job title is “software engineer I,” and can include information about the employee's experience, namely that they have three years of experience and that they have experience in the C++, Java, and C# programming languages.

The data harvesters 220 of FIG. 2 can further access information included in a second source 310j that is identified as a social network page for an individual named “John Smith.” The social network page can indicate that the individual named “John Smith” is residing in Seattle, Wash., is working for “XYZ Company,” and has a Doctor of Philosophy (Ph.D.) in computer engineering. The social network page may further include a picture of the individual “John Smith,” e.g., a picture that the individual “John Smith” associated with the social network page.

The data harvesters 220 may also access a third source 310k that is identified as a company web page for the employee “Jane Doe.” The company web page can include information that indicates that the job position held by the employee “Jane Doe” at the company “Big Software Co” is a “software engineer I” position, that the location of the employee's job is in Seattle, Wash., and that the employee “Jane Doe” has a B.S. in electrical engineering and a Master of Science (M.S.) degree in computer science. The information can further indicate that the employee “Jane Doe” is proficient in both English and French, and that they have experience in project management, object-oriented language programming, and distributed file system software.

The data harvesters 220 can access the information at the sources 310i-310k and can provide the accessed information to the aggregator 240. In some instances, the data harvesters 220 can provide the information accessed at the sources 310i-310k to the aggregator 240 by providing copies of the sources 310i-310k to the aggregator 240, or by extracting information from the sources 310i-310k and providing the extracted information to the aggregator 240. For example, the data harvesters 220 may process the sources 310i-310k and determine information elements from the sources 310i-310k about a particular employee, group of employees, or class of employees based on the accessed information.

If not performed by the data harvesters 220, the aggregator 240 may perform similar processing on the sources 310i-310k to determine facts about a particular employee, group of employees, or class of employees based on the information included in the sources 310i-310k. For example, the aggregator 240 may receive a copy of the company web page source 310i from the data harvesters 220 and may process the company web page to determine one or more information elements related to a particular employee. In the example shown in FIG. 3, for example, the aggregator may process the source 310i and determine that the employee “John Smith” holds a “software engineer I” position, has three years of experience, and is skilled in the C++, Java, and C# programming languages.

Additionally, in some implementations, the workforce analysis system may process the information included in the source 310i or extracted from the source 310i to remove any personal information of the employee, e.g., an address or telephone number of the employee “John Smith,” so that such information is not be included in the employee profile for the employee “John Smith.” Additionally or alternatively, such information may be removed from the facts determined for the employee “John Smith” that are to be included in an employee profile of the employee “John Smith,” but may be used as identifying information for purposes of determining that information included in two or more different sources 310i-310k pertain to the same employee.

For example, if information extracted from a pair of sources 310i-310k indicates a same office telephone number for an employee, such information may be used by the workforce analysis system to determine that the pair of sources 310i-310k relate to the same employee, without including information indicating the office telephone number of the employee in an employee profile for the employee. Thus, certain personal information extracted from the sources 310i-310k by the data harvesters 220 and/or aggregator 240 may facilitate the building of robust employee profiles, without including such personal information in those employee profiles that could be used to identify or locate the employees to which those employee profiles relate.

Using these techniques, the workforce analysis system may process the sources 310i-310k and determine that the sources 310i and 310j each pertain to the same employee “John Smith,” and that the source 310k pertains to a different employee “Jane Doe.” Such a determination may be made, for example, by determining overlaps in information between the sources 310i-310k or by performing comparisons of information extracted from each of the sources 310i, 310j.

For example, the workforce analysis system may determine that both the company web page source 310i and the social network page source 310j each identify an employee of the same name, specifically “John Smith.” The workforce analysis system may also determine, by using facial recognition or other image processing techniques, that the images of the employee “John Smith” in both the company web page source 310i and the social network page source 310j likely show the same person. The workforce analysis system may additionally or alternatively determine that the social network page for the employee “John Smith” indicates that they are an employee for “XYZ Company,” which matches the name of the company associated with the company web page source 310i. The workforce analysis system may consider one or more of these determinations, and based on these determinations may classify the pair of sources 310i, 310j as relating to the same employee.

Additionally or alternatively, the workforce analysis system may rely on information external to that accessed at the sources 310i, 310j to determine that the sources each relate to the same employee named “John Smith.” For example, the workforce analysis system may determine from the social network profile source 310j that the employee “John Smith” has a Ph.D. in computer engineering, and may access information external to the workforce analysis system that indicates that common skills for employees with that degree include proficiencies in one or more of the C++, Java, or C# programming languages. The workforce analysis system may rely on this information to determine that the pair of sources 310i, 310j are likely to relate to the same employee. Similarly, the workforce analysis system may access external information that indicates that the employer “XYZ Company” is located in or has a presence in Seattle, Wash. Based on this information, and the indication that the employee “John Smith” works for “XYZ Company,” the workforce analysis system may determine that the company web page source 310i for the employee “John Smith” and the social network page source 310j for the employee “John Smith” likely relate to the same employee.

Based on determining that the pair of sources 310i, 310j relate to the same employee “John Smith,” the workforce analysis system can create or augment an employee profile 345a associated with the employee “John Smith.” In some implementations, the workforce analysis system can assign an identifier to an employee profile that is associated with a particular employee. For example, the identifier may be assigned to an employee profile, such as the employee profile 345a, instead of including information in the employee profile that identifies the particular employee. Thus, such an identifier may be associated with an employee profile in lieu of including information in the employee profile that would indicate a person's name, address, telephone number, or other identifying information. By associating an employee profile with an identifier in lieu of including information in the employee profile that can be used to identify the employee, the employee profile can be used by the workforce analysis system in generating demographic information without the employee profile being directly traceable to any particular individual.

As shown in FIG. 3, for example, the workforce analysis system can determine that the information included in the sources 310i, 310j pertains to the same employee named “John Smith,” can generate a new employee profile 345a, can associate the new employee profile 345a with a unique identifier, such as the identifier “123123,” and can include the determined information for the employee “John Smith” in the employee profile 345a. This is shown in FIG. 3, where the employee profile 345a associated with the identifier “123123” indicates that the employee holds a “software engineer I” position, is located in Seattle, Wash., is skilled in object-oriented languages, of which C++, Java, and C# are examples, and has a Ph.D. in computer science, without indicating personally identifying information associated with the employee. The employee profile 345a may include other information obtained from other sources 310i-310k as well, such as information indicating that the employee associated with the employee profile 345a has a B.S. in computer science, a M.S. in computer science, and an income of approximately $100,000.

In some instances, the workforce analysis system can determine that information included in the sources 310i, 310j pertains to the same employee “John Smith,” and before generating a new employee profile for the employee can determine whether an employee profile already exists for the employee. To perform such a determination, the workforce analysis system may maintain information that correlates employee profile identifiers to employee information. For example, the workforce analysis system may maintain a table, linked list, or other data structure that correlates identifiers of employee profiles with employee information. The workforce analysis system can rely on this information to identify a particular employee profile that is associated with a particular employee who has been identified from information included in or associated with the sources 310i-310k. For example, based on determining that the sources 310i, 310j relate to the employee “John Smith,” the workforce analysis system can utilize the data structure correlating employee profile identifiers and employee information to identify a particular employee profile associated with the employee “John Smith,” that is, to identify the employee profile 345a associated with the identifier “123123” from the database of employee profiles. The workforce analysis system can then augment the existing employee profile 345a with the information accessed at the sources 310i, 310j.

The workforce analysis system may rely on other methods to identify an existing employee profile based on information accessed at the sources 310i, 310j. For example, after accessing the information included in the sources 310i, 310j and determining that the information relates to the same employee “John Smith,” the workforce analysis system may perform a query on the set of employee profiles to identify an employee profile that likely pertains to the same employee. To do so, the workforce analysis system may query the set of employee profiles to identify employee profiles that include at least some of the information accessed at the sources 310i, 310j. For example, the workforce analysis system may query the set of employee profiles to locate other employee profiles that include at least some of the information accessed at the sources 310i, 310k, such as other employee profiles that are associated with employees who work at “XYZ Company,” hold “software engineer I” positions, have 3 years of experience, are experienced in C++, Java, or C#, are located in Seattle, Wash., or have a Ph.D. in computer engineering. Based on the comparison, the workforce analysis system may determine that an existing employee profile 345a is associated with one or more of these characteristics. The workforce analysis system may additionally determine a confidence measure that indicates the probability that the identified existing employee profile 345a and the information included in the sources 310i, 310j relate to the same employee. Based on determining that the confidence measure satisfies a particular threshold, the workforce analysis system may augment the existing employee profile 345a with any additional information that was included in the accessed information from the sources 310i, 310j and that was not previously included in the identified employee profile 345a.

Similarly, the workforce analysis system can determine that the company web page source 310k relates to the employee “Jane Doe” and can include the information determined from the source 310k in a new or existing employee profile associated with the particular employee “Jane Doe.” For example, the workforce analysis system can generate a new employee profile 345b for the employee “Jane Doe” and can associate the new employee profile 345b with the identifier “888999.” The workforce analysis system can add information determined from the source 310k in the employee profile 345b, including information indicating that the employee holds a “software engineer I” position, is located in Seattle, Wash., is skilled in object-oriented languages, project management, and Hadoop, e.g., as a result of their experience with distributed file systems, has a B.S. in electrical engineering and an M.S. in computer science, and is fluent in English and French.

As described above, instead of generating a new employee profile 345b for the employee “Jane Doe,” the workforce analysis system may alternatively determine that an employee profile 345b already exists for the employee “Jane Doe,” and may augment the existing employee profile 345b with any of the information accessed at the source 310k that is not already included in the employee profile 345b.

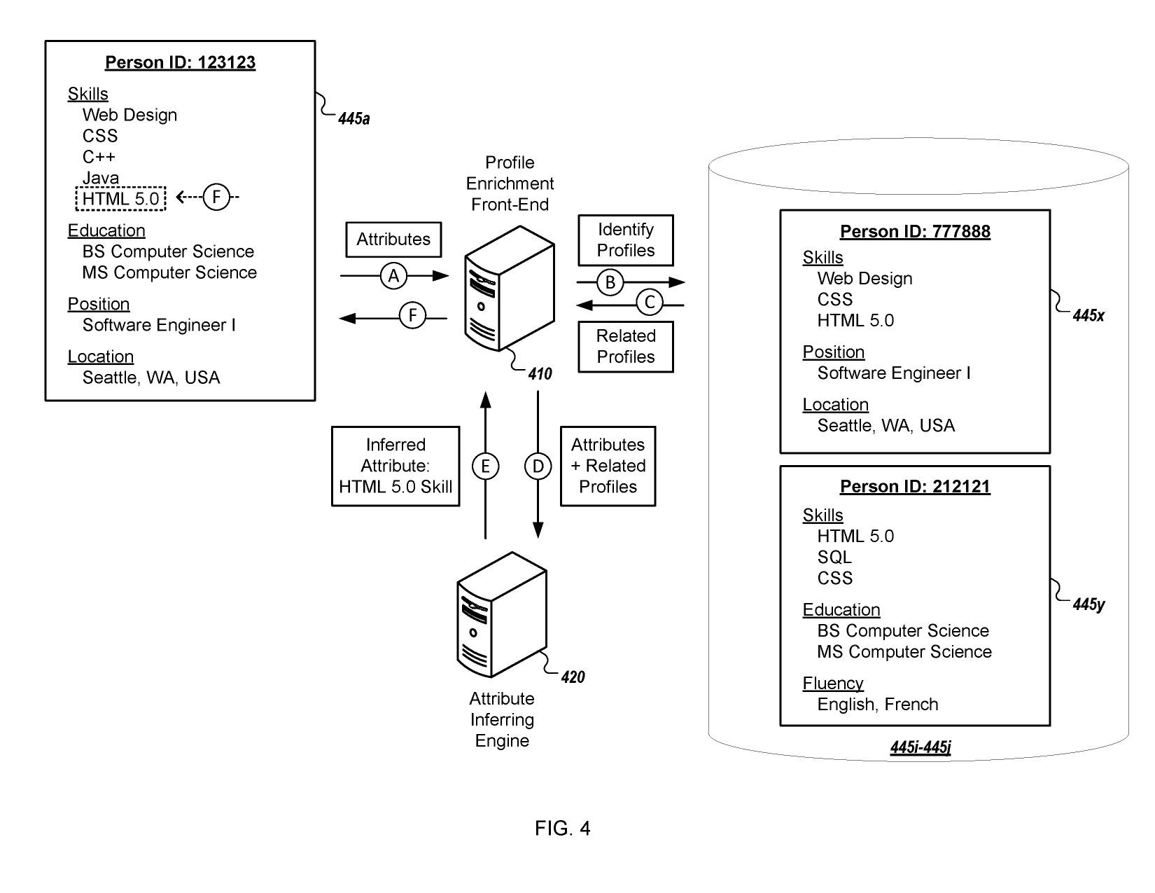

FIG. 4 depicts an example workforce analysis system for enriching an employee profile. Profile enrichment can include adding additional information to an employee profile that is determined based on similar or related employee profiles for other employees, adding additional information to an employee profile based on inferences made from the information already included in the employee profile, or adding additional information to an employee profile based on inferences made from the information already included in the employee profile and other information accessible to the workforce analysis system. The workforce analysis system of FIG. 4 includes a profile enrichment front-end 410, and an attribute inferring engine 420. The profile enrichment front-end 410 and the attribute inferring engine 420 of the system of FIG. 4 may be in communication over one or more wired or wireless connections, including one or more wired or wireless networks. In some instances, the profile enrichment front-end 410 and the attribute inferring engine 420 can be included in the same system, or may be included in separate systems. The profile enrichment front-end 410 can be capable of receiving an employee profile 445a and of accessing a set of other employee profiles 445i-445j that can be analyzed to perform profile enrichment.

For example, as shown in FIG. 4, in step (A), the profile enrichment front-end 410 can receive information that specifies the attributes included in the employee profile 445a. In some implementations, the profile enrichment front-end 410 can receive the employee profile 445a and can obtain the attributes from the employee profile 445a, for example, by extracting the attributes from the information included in the employee profile 445a. Alternatively, the profile enrichment front-end 410 can receive only information specifying the attributes included in the profile 445a without receiving the entirety of the employee profile 445a, for example, such that the attributes have been extracted from the employee profile 445a before the attributes or the employee profile 445a are provided to the profile enrichment front-end 410.

As shown in FIG. 4, for example, attributes of the employee profile 445a associated with the identifier “123123” are received by the profile enrichment front-end 410. The attributes may be extracted from the employee profile 445a such that other information associated with the employee profile 445a, such as the identifier “123123,” is not provided to the profile enrichment front-end 410. For example, attributes provided to the profile enrichment front-end 410 may include skills specified by the employee profile 445a, such as skills in web design, cascading style sheets (CSS), and the C++ and Java programming languages. The attributes may further include the educational background of an employee associated with the employee profile 445a, specifically that the employee has a B.S. in computer science and a M.S. in computer science. The attributes further include a job position of the employee associated with the employee profile 445a, namely that they hold a software engineer I position, and include a location of the employee, namely Seattle, Wash., USA.

In step (B), the profile enrichment front-end 410 receives the information specifying the attributes included in the employee profile 445a, and accesses the other employee profiles 445i-445j to identify employee profiles 445x, 445y that are related to the employee profile 445a. For example, the profile enrichment front-end 410 may query the set of employee profiles 445i-445j for employee profiles 445i-445j that include one or more of the same attributes as the employee profile 445a.

For example, based on receiving the attributes specified by the employee profile 445a, the profile enrichment front-end 410 can query the employee profiles 445i-445j to identify other employee profiles that include one or more of the attributes specified by the employee profile 445a, such as employee profiles that specify skills including web design, CSS, C++, or Java, that specify a B.S. in computer science or M.S. in computer science, that are associated with employees who hold software engineer I positions, or that are associated with employees who are located in Seattle, Wash., USA.

Based on querying the set of employee profiles 445i-445j for employee profiles that include one or more attributes of the employee profile 445a, the profile enrichment front-end 410 can identify the employee profiles 445x, 445y as related to the employee profile 445a. At step (C), the profile enrichment front-end 410 can then access or receive the related employee profiles 445x, 445y, or information specifying the attributes included in the one or more related employee profiles 445x, 445y. Specifically, the profile enrichment front-end 410 may identify the employee profile 445x as related to the employee profile 445a based on both profiles including attributes for web design and CSS skills, a software engineer I position, and a location in Seattle, Wash., USA. The profile enrichment front-end 410 may identify the employee profile 445y as related to the employee profile 445a based on both profiles specifying skills in CSS, and based on the employees associated with the employee profiles 445a,445y having a B.S. in computer science and a M.S. in computer science.

Based on identifying the related employee profiles 445x, 445y, the profile enrichment front-end 410 can access the related employee profiles 445x, 445y, or may access or receive information specifying attributes included in the related employee profiles 445x, 445y. For example, the profile enrichment front-end 410 may receive information indicating that the employee profile 445x associated with an identifier “777888” includes information specifying skills of web design, CSS, and HTML 5.0, a job position of software engineer I, and a location of Seattle, Wash., USA. Similarly, the profile enrichment front-end 410 may receive information indicating that the employee profile 445y associated with an identifier “212121” includes information specifying skills of HTML 5.0, CSS, secure query language (SQL), an B.S. in computer science and M.S. computer science, and English and French language proficiency. Alternatively, in some implementations, the profile enrichment front-end 410 may receive only the attributes of the related employee profiles 445x, 445y without receiving the complete employee profiles 445x, 445y. For example, the attributes of the related employee profiles 445x, 445y may be extracted from the employee profiles 445x, 445y and provided to the profile enrichment front-end 410 without other information, e.g., the identifiers of the related employee profiles 445x, 445y.

In some implementations, the profile enrichment front-end 410 can identify a particular attribute of the employee profile 445a, and can query the set of employee profiles 445i-445j for employee profiles that also specify the particular attribute. For example, the profile enrichment front-end 410 may identify only employee profiles in the set of employee profiles 445i-445j that also specify a CSS skill as being related to the employee profile 445a. In this way, the profile enrichment front-end 410 can limit profile enrichment to the identification of attributes that are common in other employees that also have a CSS skill.

At step (D), In response to receiving the attributes of the employee profile 445a and the attributes of the related employee profiles 445x, 445y, the profile enrichment front-end 410 can provide the attributes of the employee profile 445a and the attributes of the related employee profiles 445x, 445y to the attribute inferring engine 420. In some examples, the profile enrichment front-end 410 may provide the entirety of the employee profiles 445a, 445x, 445y to the attribute inferring engine 420, or may only provide information specify the attributes included in those employee profiles 445a, 445x, 445y to the attribute inferring engine 420.

At step (E), the attribute inferring engine 420 receives the attributes of the employee profile 445a and the attributes of the related employee profiles 445x, 445y, identifies one or more inferred attributes to include in the employee profile 445a, and provides information to the profile enrichment front-end 410 that specifies the one or more inferred attributes. Inferred attributes to include in the employee profile 445a can include attributes that are not included in the employee profile 445a but that are included in at least one of the related employee profiles 445x, 445y.

For example, as shown in FIG. 4, the attribute inferring engine 420 may determine that each of the related employee profiles 445x, 445y specify the skill HTML 5.0, and since the employee profiles 445x, 445y are related to the employee profile 445a, the attribute inferring engine 420 may determine that HTML 5.0 should be included as a skill in the employee profile 445a. Thus, the attribute inferring engine 420 may provide information to the profile enrichment front-end 410 specifying the skill HTML 5.0 as a skill to be included in the employee profile 445a.

In some implementations, inferring an attribute to include in the employee profile 445a may involve identifying a skill that is commonly included in at least some, i.e., one or more, of the related employee profiles 445x, 445y. For example, the attribute inferring engine 420 may identify each of the attributes included in the related employee profiles 445x, 445y that are not already specified by the employee profile 445a. Thus, in the example shown in FIG. 4, the attribute inferring engine 420 can identify the skills HTML 5.0, SQL, English proficiency, and French proficiency as attributes that are included in the employee profiles 445x, 445y that are not already included in the employee profile 445a. The attribute inferring engine 420 may then identify one or more these attributes as inferred attributes based on determining that the employee associated with the employee profile 445a is more than likely to have the inferred attributes.

In some implementations, inferring an attribute may involve determining that a sufficient portion of the related employee profiles 445x, 445y, or a sufficient number of the related employee profiles 445x, 445y, specify the attribute. For example, based on determining that all or at least half of the related employee profiles 445x, 445y specify the HTML 5.0 attribute, the attribute inferring engine 420 may identify the HTML 5.0 attribute as an attribute to include in the employee profile 445a. Alternatively, the attribute inferring engine 420 may determine that at least two of the related employee profiles 445x, 445y include the HTML 5.0 attribute, and may therefore identify the HTML 5.0 attribute as one to be included in the employee profile 445a.

In some implementations, inferring an attribute may involve determining a statistical number of employees that are likely to have a certain attribute or set of attributes, a statistical probability of a specific employee or group of employees having a certain attribute or set of attributes. For example, a statistical approach can be applied to determine whether a particular employee is likely versed in all of CSS, HTML 5.0, and Java. The attribute inferring engine 420 can access information from employee profiles that are identified as being related to a particular employees profile of the particular employee, and can determine whether to enrich the particular employee profile with one or more of the CSS, HTML 5.0, or Java skills.

For a set of three skills A, B and C, the probable number of employees in a set who have all three skills is given by (A∩B∩C)=(A∪B∪C)+(A∩B+B∩C+C∩A)−(A+B+C). Moreover, (A∩B)=min(A,B)*R_{AB}, where R_{AB} is a coefficient representing a strength of relationship between skill A and skill B, (B∩C)=min(B,C)*R_{BC}, where R_{BC} is a coefficient representing a strength of relationship between skill B and skill C, and (C∩A)=min(C,A)*R_{CA}, where R_{CA} is a coefficient representing a strength of relationship between skill C and skill A. The result provides an indication of the probable number of employees in a set having all three of skills A, B, and C. If this probability is determined to satisfy a threshold, then all three skills or a skill not indicated in an employee profile may be added to the employee profile to enrich the employee profile.

To provide a numeric example, for 100 employee profiles in a representative group, e.g., a group of software engineer I employees in Seattle, the attribute inferring engine 420 may determine that 50 employee profiles specify the CSS skill (i.e., skill A), 40 employee profiles specify the HTML 5.0 skill (i.e., skill B), and 75 employee profile specify the Java skill (i.e., skill C). The attribute coefficient engine 420 may further access or determine a coefficient representing the strength of the relationship between CSS and HTML 5.0 of 0.6, a coefficient representing the strength of relationship between HTML 5.0 and Java of 0.3, and a coefficient representing the strength of the relationship between Java and CSS of 0.7. Using the above statistical equation, the number of employee profiles that are likely to correspond to employees having all three skills can be computed as (CSS∩HTML 5.0∩Java)=(CSS∪HTML 5.0∪Java)+(CSS∩HTML 5.0+HTML 5.0∩Java+Java∩CSS)−(CSS+HTML 5.0+Java)=(100)+(24+12+35)−(50+40+75)=6. Thus, approximately 6 of the employee profiles can be expected to have all of the CSS, HTML 5.0, and Java skills.

In other instances, different statistical approaches may be required. For example, for a set of more than three skills A, B, C, and D, the probable number of employees having three of those skills, e.g., A, B, and C, is represented by (A∩B∩C)=X∩Y=min(X,Y)*R_{XY}. In this case, X=min(A∩B, B∩C, C∩A), such that if X=A ∩B then Y=C and R_{XY}=R_{CA}*R_{CB}, where R_{CA} is the same as defined above and R_{CB} is a coefficient representing a strength of relationship between skill C and skill B. If X=B∩C, then Y=A and R_{XY}=R_{AB}*R_{AC}, where R_{AB} is the same as defined above and R_{AC} is a coefficient representing a strength of relationship between skill A and skill C. If X=C∩A, then Y=B and R_{XY}=R_{BC}*R_{BA}, where R_{BC} is the same as defined above, and R_{BA} is a coefficient representing a strength of relationship between skill B and skill A. Applying this to the scenario detailed above, but with a fourth skill, e.g., Python, included in the set of potential skills, the number of employees having three of those skills, e.g., CSS, HTML 5.0, and Java can be found. For the numerical example above, the number of employees having those three of the four skills is computed by determining that X=HTML 5.0∩Java=12, and so Y=CSS=50 and R_{XY}=0.6*0.7=0.42. Thus, (CSS∩HTML 5.0∩Java)=12*0.42=5 proximately. Thus, using this method approximately 5 of the employee profiles of the set can be expected to have all of the CSS, HTML 5.0, and Java skills.

One or more of the employee profiles in the set may be enriched based on a statistical determination. For example, a particular employee may be to include a particular one of the skills or to specify a probability of a particular employee having a particular skill. In addition to enriching employee profiles, similar techniques may also be used in determining demographics. For example, the analysis models 265 of FIG. 2 may include a similar statistical model that may be used by the analyzer 260 in estimating a number of employees in a particular class that have a set of skills, e.g., how many software engineer I employees in Seattle are likely to be versed in all three of CSS, HTML 5.0, and Java.

In some implementations, identifying an inferred attribute to include in the employee profile 445a may involve determining a confidence measure for the attribute, and determining that the confidence measure satisfies a threshold. For example, a confidence measure may be determined for the skill HTML 5.0 as a potential inferred attribute to include in the employee profile 445a. The attribute inferring engine 420 may determine the confidence measure based on any number of factors. For example, the attribute inferring engine 420 may calculate a confidence measure for the skill HTML 5.0 based on a number of related employee profiles 445x, 445y that specify the skill, or based on a proportion of the related employee profiles 445x, 445y that specify the skill.

The confidence measure may reflect whether the related employee profiles 445x, 445y that include the skill have had the skill included in the employee profiles 445x, 445y based on explicit information accessed by the workforce analysis system. For example, if the skill HTML 5.0 was included in the related employee profile 445x because information accessed by the workforce analysis system, e.g., at a source 210, specifically named the skill for the employee associated with the employee profile 445x, then the confidence measure for the skill HTML 5.0 may be increased. In contrast, if the skill HTML 5.0 was added to the related employee profile 445y based on the skill HTML 5.0 being inferred, e.g., based on other employee profiles that are related to the employee profile 445y including the skill HTML 5.0, then the confidence measure for the skill HTML 5.0 may be increased by a lesser amount, decreased, or may not affect the confidence measure for the skill HTML 5.0. For example, inferred skills may be excluded from being used to further infer skills of other employees in some implementations.

Other factors may also be considered when computing a confidence measure for a particular attribute. For example, the attribute inferring engine 420 may consider how recently the HTML 5.0 skill has been added to the related employee profiles 445x, 445y. The attribute inferring engine 420 may also consider how robust, or trustworthy each of the related employee profiles 445x, 445y that includes the skill HTML 5.0 are determined to be, for example, based on how much information is included in those related employee profiles 445x, 445y, the number of sources 210 relied upon for information included in each of the related employee profiles 445x, 445y, or based on other information that may be indicative of the robustness or trustworthiness of a particular related employee profile 445x, 445y.

In some implementations, the confidence measure may vary based on, for example, the source of information that provided information about the attribute, or measures of related profiles. For example, an employee whose company biography page lists a skill may be assigned a confidence measure indicating a high confidence, e.g., 0.9, while an individual who is only inferred to have the skill is assigned a confidence measure for the skill that is lower, e.g., 0.6. The confidence measure of an inferred skill may be a function of the confidence measures for the skill of profiles determined to be similar, e.g., as an average or median value among confidences measures for the skill among profiles in the set. As another example, an inferred skill may be given a higher confidence measure if a higher proportion of similar profiles have the skill, e.g., an inferred skill will have a higher confidence measure if 80% of others in the role have the skill than if 50% of others have the skill. Similarly, the confidence measure may vary based on a degree of similarity between profiles. Accordingly, the confidence measure may be higher when a skill is inferred based on another employee profile for the same industry, location, and job role, than if the employee profile had fewer similarities.

The confidence measure may also reflect the strength of a relationship between the candidate inferred attribute and other attributes included in an employee profile. For example, the confidence measure for the HTML 5.0 skill may be determined based in part on how closely related that skill is to other attributes included in the related employee profiles 445x, 445y and/or the profile 445a. For example, the confidence measure may consider how closely related the HTML 5.0 skill is determined to be to a CSS or SQL skill, to a software engineer I position, to a B.S. or M.S. in computer science, or to other attributes.

In some implementations, the strength of a relationship between two attributes may be based at least in part on a taxonomy of attributes, where the strength of the relationship is determined based on the relationship between the attributes in the taxonomy. Such a taxonomy may establish a hierarchy of attributes, wherein certain attributes may be characteristic of other, higher-level attributes, e.g., both HTML 5.0 and CSS skills may be identified as attributes that are related to web design skills more generally, that is, as skills that are beneath the web design skill in the taxonomy hierarchy. In some instances, the strength of a relationship between the attributes may be based on a distance between the two attributes in the taxonomy hierarchy.

Based on determining the confidence measure for an inferred attribute, the workforce analysis system may determine whether to add the inferred attribute to the employee profile 445a by comparing the confidence measure to a threshold. For example, the attribute inferring engine 420 may compare the confidence measure of the inferred attribute to a predetermined threshold, or a threshold determined by the attribute inferring engine 420, to determine whether the confidence measure satisfies the threshold. Determining that the confidence measure satisfies the threshold may prompt the attribute inferring engine 420 to identify the inferred attribute as an attribute to add to the employee profile 445a.

In some implementations, the threshold may be predetermined, such that the attribute inferring engine 420 can access the predetermined threshold and compare the confidence score of the candidate inferred attribute to the predetermined threshold. In other examples, the threshold may be influenced or specified by a user. For example, the end user 281 or another user, e.g., another user associated with a company that provides the services offered by the workforce analysis system, may specify a threshold explicitly, e.g., by specifying a confidence measure value that must be satisfied. Alternatively, the user may specify only a qualitative characteristic for the threshold to which the confidence measure is compared. For example, if the users want to ensure that only attributes with high confidence measures are identified as inferred attributes to add to the employee profile 445a, then the users may specify that the necessary confidence should be “high,” and the threshold may be adjusted based on this indication.

In other implementations, the attribute inferring engine 420 may determine the threshold based on one or more factors. For example, the attribute inferring engine 420 may determine the threshold based on the number of attributes included in the employee profile 445a or the related employee profiles 445x, 445y. Additionally or alternatively, the threshold may be determined based in part on the number of related employee profiles 445x, 445y that are identified by the profile enrichment front-end 410. The threshold may be determined based in part on the nature of the inferred attribute. For example, an inferred attribute that is of high importance, e.g., leadership, or that is very specific, e.g., HTML 5.0 expertise, may necessitate a higher threshold to ensure that the inferred characteristic is not inadvertently added to the employee profile 445a. The threshold may also be determined in part based on how common the inferred characteristic is, for example, for employees having a specific job position or that are located in a specific area. For example, if a candidate inferred attribute is considered by the attribute inferring engine 420 to be a common attribute, an attribute that is common to a specific job position specified by the employee profile 445a, or an attribute that is common to the geographical area specified by the employee profile 445a, then a lower threshold may be determined by the attribute inferring engine 420 since there is a high probability that the employee associated with the inferred attribute will in fact have the inferred attribute. Conversely, a threshold may be set higher by the attribute inferring engine 420 for inferred attributes that are more rare, to help ensure that the inferred attribute is not erroneously added to the employee profile 445a. Other factors may be considered by the attribute inferring engine 420 in determining the threshold. For example, if a user specifies that the threshold for including a candidate inferred attribute in employee profiles should be “high,” the attribute inferring engine 420 may consider this in determining the threshold.

Based on comparing the confidence measure determined for the candidate inferred attribute to the threshold, the attribute inferring engine 420 can determine that the inferred attribute should be added to the employee profile 445a, and so many transmit information to the profile enrichment front-end 410 that specifies the inferred attribute. For example, the attribute inferring engine 420 can transmit information to the profile enrichment front-end 410 that indicates that the HTML 5.0 attribute should be added to the employee profile 445a.

At step (F), based on receiving the information specifying the inferred attribute to add to the employee profile 445a, the profile enrichment front-end 410 can add the inferred attribute to the employee profile 445a. For example, the profile enrichment front-end 410 can receive information specifying the HTML 5.0 attribute, and can add the HTML 5.0 attribute to the employee profile 445a as an inferred attribute. Adding the HTML 5.0 attribute to the employee profile 445a may involve accessing the employee profile 445a, for example, from the set of employee profiles 245, and modifying the employee profile 445a to include information that specifies the HTML 5.0 attribute. In some implementations, adding the HTML 5.0 attribute to the employee profile 445a may include adding the HTML 5.0 attribute to the employee profile 445a with information indicating that the HTML 5.0 attribute is an inferred attribute. In this way, the HTML 5.0 attribute may be distinguished from other attributes in the employee profile 445a that may have been determined directly from one or more sources 210 that have been accessed by the workforce analysis system.

In some implementations, other information may be relied upon by the system of FIG. 4 in identifying attributes to add to an existing employee profile as a part of employee profile enrichment. For example, attributes may be inferred based on existing information and attributes included in the employee profile, by identifying attributes that are related to attributes already specified by the employee profile.

One source of inferred attributes may be a taxonomy of attributes that may be maintained by the workforce analysis system and used to identify related attributes to those attributes already specified by an employee profile. For example, the attribute inferring engine 420 of FIG. 4 may maintain and have access to a taxonomy of attributes that indicates relationships between different attributes. The attribute inferring engine 420 may receive information specifying attributes included in the employee profile 445a, and may infer related attributes to add to the employee profile 445a based on the taxonomy. For example, the taxonomy may be a graph data structure in which different attributes correspond to nodes in the graph and edges between the nodes represent relationships between the attributes. In other implementations, the taxonomy may be a hierarchical data structure such that attributes that are included in a lower level of the hierarchy may be related to higher level skills. For example, an employee known to have the more specific skill of “C++ programming” may be inferred to also have the more general skill of “object oriented programming.” Other structures may be implemented for the taxonomy of attributes to describe their relationships.

Using the taxonomy, the attribute inferring engine 420 may infer attributes to include in the employee profile 445a. Based on receiving information indicating the attributes of the employee profile 445a, the attribute inferring engine may identify an attribute that is related to one or more of the attributes already included in the employee profile 445a, and may determine to include the attribute in the employee profile 445a. In some implementations, determining to include an inferred attribute in an employee profile 445a may involve determining a confidence measure for the inferred attribute, and including the inferred attribute in the employee profile 445a only if the confidence measure satisfies a threshold.

For example, the attribute inferring engine 420 may receive information specifying the web design skill that is included in the employee profile 445a, may access a hierarchical taxonomy of attributes, and may determine that HTML 5.0 is a lower-level attribute descendent from the web design skill. Based on this determination, the attribute inferring engine 420 may provide information to the profile enrichment front-end 410 that causes the profile enrichment front-end 410 to include the HTML 5.0 skill in the employee profile 445a. In some examples, the attribute inferring engine 420 may also identify a confidence score for the HTML 5.0 skill, for example, based on the employee profile 445a also including the skill CSS that is also a descendent skill from the more general web design skill. The attribute inferring engine 420 may determine that the confidence score for the HTML 5.0 skill satisfies a threshold, and may therefore provide information to the profile enrichment front-end 410 that causes the profile enrichment front-end 410 to include HTML 5.0 in the employee profile 445a.

In some instances, the attribute inferring engine 420 may be configured to identify inferred attributes that are at a lower level than an attribute included in an employee profile, but not attributes that are at a higher level in the hierarchy than attribute included in the employee profile. For example, if an employee profile specifies a skill in romance languages, the attribute inferring engine 420 may identify, as an inferred attribute, French language proficiency. However, the attribute inferring engine 420 may not infer that an employee has a skill in romance languages generally based on an employee profile corresponding to that employee including French language proficiency as a skill, to avoid the attribute inferring engine 420 from assuming skills that an individual is not likely to have, and including those skills in the employee profile.

In some instances, this relationship between attributes may be described by the distinctions between anchor skills and derived skills, where anchor skills are typical more foundational skills, e.g., those skills that are higher in a taxonomy hierarchy or skill nodes that have a number of edges to related skills. In some instances, these anchor skills may be considered foundational skills, such that other skills depend from mastery of that foundational skill. For example, an employee profile may specify that an employee associated with the employee profile is a patent lawyer, and the attribute inferring engine 420 may identify derived skills that are associated with the foundational attribute of the employee's position as a patent lawyer. Such derived skills may include those skills that would typically be associated with the employee's position as a patent lawyer, for example, skills in persuasive writing, technical writing, etc. In some instances, anchor and derived skills may be specified in a taxonomy as described, or may be specified by groups or packages of skills, such that an employee profile that is identified as including a specific skill can be enriched with one or more of the other skills in the skill package. Rules for inferring skills may be set based on the classification of the skill. For example, anchor skills may be able to be inferred from one profile to another. However, inferred skills may not be able to be inferred to further profiles, or a higher level of similarity between profiles or a higher proportion of profiles that include the skill may be required for a skill that has been inferred to serve as the basis for inferring the skill to further profiles.

In some implementations, the system of FIG. 4 may enrich a profile by augmenting the employee profile with synonymous or highly related skills. For example, based on determining that an employee profile specifies a skill in legal writing, the attribute inferring engine 420 may identify persuasive writing as a synonymous skill to legal writing, and may determine to enrich the employee profile by adding persuasive writing to the employee profile. Similarly, if the attribute inferring engine 420 determines that an employee profile specifies legal writing as a skill of the employee associated with the employee profile, the attribute inferring engine 420 may identify a skill in word processing as being highly related to legal writing, e.g., since most legal writing would require the employee to utilize a word processor program. The attribute inferring engine 420 may therefore determine to add the word processing skill to the employee profile.

In other implementations, the system of FIG. 4 may perform profile enrichment by accessing information in external sources that is relevant to a particular employee profile, and enriching the profile by adding information from those sources to the employee profile. For example, external sources may include any sources that are not directly related to the particular employee that is associated with an employee profile, but that is identified as relating to that employee such that information from those sources may be included in the employee profile. Such sources may include job postings for jobs matching or similar to that of the employee, company web pages that indicate the skills or expertise of the company for whom the employee works, information from academic curricula or university web pages that are related to the employee, sources relating to colleagues of the employee, information indicating technical skills trends for the industry or job position that the employee works in, or other information.

For example, based on determining that the employee profile 445a specifies that the employee associated with the employee profile 445a holds a software engineer I job position, the attribute inferring engine 420 can identify a job posting for a software engineer I position at an external source from the workforce analysis system. The attribute inferring engine 420 may determine that the job posting includes a requirement for HTML 5.0, and may therefore determine to enrich the employee profile 445a by adding HTML 5.0 as a skill.

In some implementations, the attribute inferring engine 420 may additionally determine a confidence score for the attribute inferred from the external information, and may determine to add the attribute inferred from the external information to the employee profile 445a if the confidence measure satisfies a threshold. The confidence score may be determined, for example, based on a number of external sources that specify the attribute inferred from the external information, based on a determined strength of relationship between the external information and the employee associated with the employee profile 445a, e.g., such that an attribute inferred from a job posting for the same job position as the employee at the same employer as the employee would have a great confidence than an attribute inferred from a job posting for a slightly different job position at a different employer. Other factors may be considered in determining the confidence score, for example, the relationship between the attribute inferred from the external information and other attributes included in the employee profile 445a, e.g., based on a taxonomy of attributes. The attribute inferring engine 420 may compare the determined confidence score for the inferred attribute to a threshold, and may determine to enrich the employee profile 445a with the attribute inferred from the external information if the confidence measure satisfies the threshold.

In some implementations, determining to enrich an employee profile with a particular attribute may involve determining that the attribute is statistically significant and therefore can be included in the employee profile, determining that the attribute satisfies a modified counting method, or that the attribute satisfies a confidence interval analysis. For example, in lieu of or in addition to evaluating a confidence measure for an attribute prior to enriching an employee profile with the attribute, a standard deviation or chi-squared analysis may be determined for the attribute in view of the employee profile, information included in related employee profiles, or other information as discussed, and the attribute may be included in the employee profile if this analysis is satisfies, e.g., if there is a statistical significance such that the attribute can likely be included in the employee profile. Similarly, a binomial proportion confidence interval test, such as a Wald interval test, may be performed on the employee profiles and other information related to a particular employee profile to determine whether to enrich an employee profile with a particular candidate inferred characteristic. Other statistical analyses may be performed on employee profile information and other information in determining when to enrich a profile with a particular attribute. Similar techniques may also be used in developing the taxonomy of attributes discussed above, for example, to determine if two attributes should be identified as related attributes in the taxonomy.

In some implementations, the workforce analysis system may analyze employee profiles and identify employee profiles as trustworthy or untrustworthy employee profiles, or may assign the employee profiles a score indicative of the robustness of the employee profile. For example, the workforce analysis system may consider one or more factors in determining whether an employee profile is trustworthy and/or in determining a robustness score to assign to the employee profile. Such factors may include, for instance, how many attributes are included in the employee profile, how many sources have been relied upon in generating the employee profile, what portion of the attributes specified by the employee profile have been determined from sources specific to the employee associated with the employee profile and what portion of those attributes have been inferred from a profile enrichment process, based on confidence measures determined for attributes specified by the employee profile, based on a number of related profiles that include similar attributes to that included in the employee profile, or based on other information.

In some instances, whether an employee profile is identified as trustworthy or untrustworthy, or a robustness score for the employee profile, may be considered by the workforce analysis system when determining to enrich another employee profile with attributes specified by the employee profile, or in determining whether or what weight should be granted to employee profiles analyzed by the workforce analysis system for purpose of generating workforce or job market demographic information.

In some implementations, the workforce analysis system may refresh an employee profile by crawling sources for additional attributes to add to the employee profile, by reviewing sources previously relied on by the workforce analysis system in generating the employee profile, or by otherwise updating the employee profile to ensure that the employee profile is current. For example, the workforce analysis system may track sources relied upon for developing each employee profile, and may occasionally refresh the sources and crawl the sources again to identify new attributes to include in the employee profile. Tracking the evolution of an employee profile may also be used by the workforce analysis system to determine or predict changes in a workforce or job market over time, by tracking overall changes in the evolution of employee profiles for specific industries, jobs, and/or geographical areas.

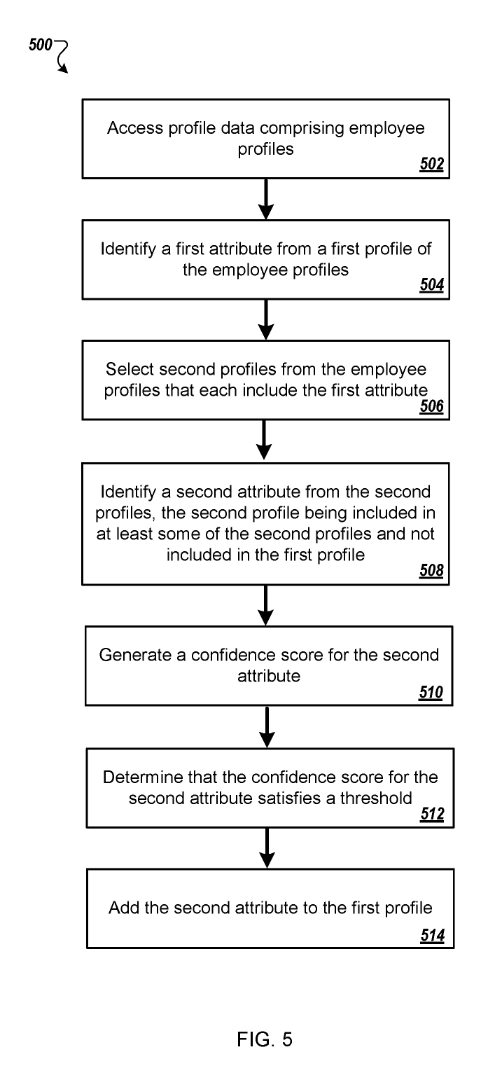

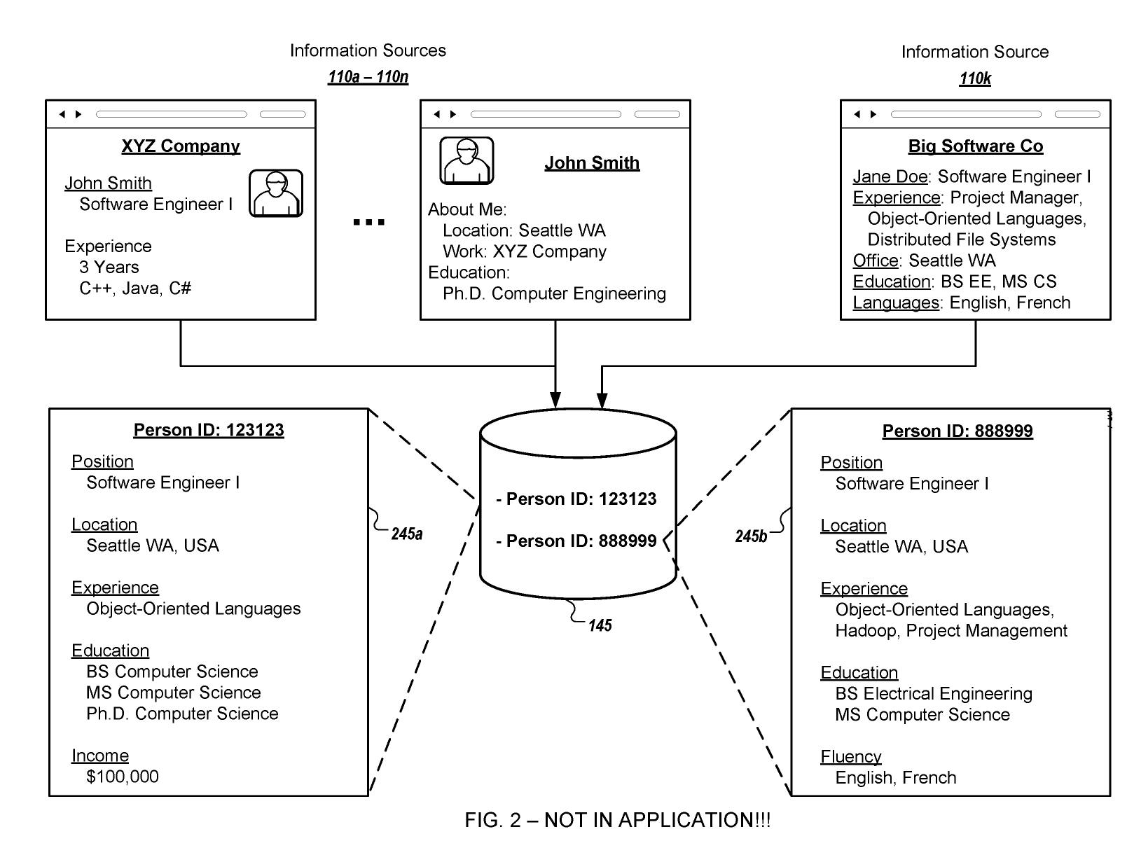

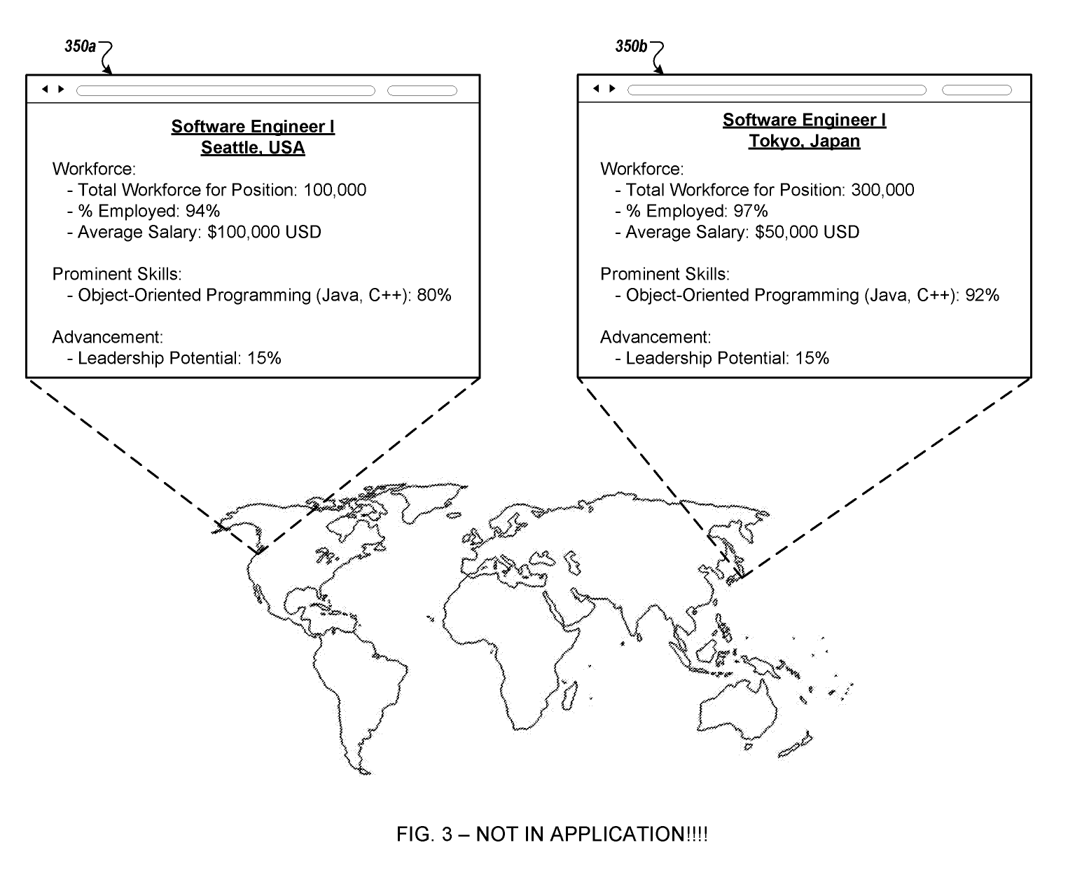

FIG. 5 illustrates an example process 500 performed by a workforce analysis system to enrich an employee profile associated with a particular employee. In some implementations, the process 500 of FIG. 5 may be performed by the workforce analysis system of FIG. 2, such as by the aggregator 240 or analyzer 260 of the workforce analysis system in conjunction with the set of employee profiles 245 and/or the set of analysis models 265.

Profile data is accessed that comprises employee profiles that each correspond to a different employee, where each employee profile includes one or more attributes of the corresponding employee that were determined from publicly available Internet data describing the corresponding employee (502). For example, the workforce analysis system can access the set of employee profiles 245 that are maintained by the workforce analysis system. Each of the employee profiles 245 can be specific to a particular employee, and can include information that indicates attributes about the particular employee's professional background or professional competencies, as well as other information, such as the particular employee's location. The information included in each employee profile can be information that the workforce analysis system located at one or more sources 210.

A first attribute that is included in a first employee profile is identified, where the first employee profile corresponds to a particular employee (504). For example, the workforce analysis system may select a particular employee profile from among the set of employee profiles 245, and may identify a particular attribute that is included in the selected employee profile. The particular attribute may be, for instance, a particular job position, skill, industry, language proficiency, an attribute related to educational background, a certification or license attribute, a geographical area, or any other information element included in the particular employee profile.

One or more second profiles are selected from the profile data that each include the first attribute, where the one or more second profiles each correspond to an employee who is not the particular employee (506). For example, the workforce analysis system can access the set of employee profiles 245 and can identify one or more other employee profiles other than the first profile that also include information matching the first attribute. Each of these other employee profiles are associated with a particular employee that is different from the employee associated with the first employee profile, such that the workforce analysis system is effectively identifying other employees that have the first attribute in common. As an example, if the identified first attribute is a professional certification that the particular employee associated with the first employee profile has obtained, the workforce analysis system in selecting the second profiles effectively identifies other employees that also have the professional certification.

A second attribute that is included in at least some of the selected second profiles is identified from the selected second profiles, wherein the second attribute is different from the first attribute and is not included in the first employee profile (508). For example, the workforce analysis system can identify a particular attribute that specified by one or more of the selected second employee profiles but that is not specified by the first employee profile. In the instance where the identified first attribute is a professional certification that each of the first employee profile and the selected second profiles have in common, the workforce analysis system can identify an attribute, such as a particular skill, that is identified by a multiplicity of the selected second profiles but that is not specified by the first employee profile.

A confidence score is generated for the identified second attribute based at least in particular on a number of the second employee profiles that specify the second attribute (510). For example, the workforce analysis system can determine a number of the selected second employee profiles that include information indicating that employees corresponding to those employee profiles each have a certain skill. The workforce analysis system can generate a confidence score for the skill based at least on the number of the selected second employee profiles that include information indicating that employees corresponding to those employee profiles have the skill.

The confidence score for the second attribute can be determined to satisfy a threshold (512). For example, based on generating the confidence score for the second attribute, the workforce analysis system can compare the confidence score for the second attribute to a threshold. Based on the comparison, the workforce analysis system can determine that the confidence score for the second attribute satisfies the threshold. In some examples, the threshold may be satisfied based on determining that the generated confidence score is greater than, or less than, the threshold. The threshold may be a predetermined threshold or a threshold that is determined or altered by the workforce analysis system while performing the process 500. For example, the threshold may be determined based on the number of selected second profiles, based on determining other attributes other than the second attribute that are specified by at least some of the selected second employee profiles and not by the first employee profile, and/or based on the number of the selected second employee profiles that specify the other attributes. Other factors may be considered in determining the threshold.

Based on determining that the confidence score for the second attribute satisfies the threshold, the second attribute can be added to the first employee profile (514). For example, based on determining that a confidence score for a skill that is not included in the first employee profile but that is included in at least some of the second employee profiles satisfies a threshold, the workforce analysis system can add the skill to the information included in the first employee profile. To do so, the workforce analysis system can access the first employee profile at the set of employee profiles 245, and can modify the first employee profile to include information specifying the second attribute. In doing so, the workforce analysis system has enriched the first employee profile to include an attribute that the particular employee associated with the first employee profile most likely has, even though information specifying the second attribute was not included in the sources 210 that the workforce analysis system identified as relating to the particular employee and used to generate the first employee profile.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

For instances in which the systems and/or methods discussed here may collect personal information about users, or may make use of personal information, the users may be provided with an opportunity to control whether programs or features collect personal information, e.g., information about a user's social network, social actions or activities, profession, preferences, or current location, or to control whether and/or how the system and/or methods can perform operations more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, such as to a city, ZIP code, or state level, so that a particular location of a user cannot be determined. Thus, the user may have control over how information is collected about him or her and used.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims may be performed in a different order and still achieve desirable results.

What is claimed is:

1. A system comprising:
one or more computers and one or more storage devices storing instructions that are operable, when executed by the one or more computers, to cause the one or more computers to perform operations;
a plurality of harvester modules configured to access information included in resources that are publicly available over the Internet;
an aggregator subsystem configured to:
identify attributes of employees including skills of the employees, the attributes being specified in the resources;
determine individual employees related to the resources; and
add, to employee profiles that each correspond to a different employee, the attributes identified from the resources, wherein each attribute added to an employee profile is identified from a resource that is determined to be related to an employee that corresponds to the employee profile;
an attribute inferring engine configured to:
access the employee profiles;
identify, from a first profile of the employee profiles, a first attribute that is included in the first profile, the first profile corresponding to a particular employee;
select, from among the employee profiles, second profiles that each include the first attribute and correspond to an employee other than the particular employee;
identify, from the second profiles, a second attribute that is included in at least some of the second profiles, wherein the second attribute is different from the first attribute and is not included in the first profile;
generate a confidence score for the second attribute based in part on a number of the second profiles that specify the second attribute;
determine that the confidence score for the second attribute satisfies a threshold; and
add the second attribute to the first profile based at least on determining that the confidence score determined for the second attribute satisfies the threshold; and
an analyzer subsystem that is configured to determine characteristics of subsets of employees in different geographical areas based on performing an analysis of the skills included in the employee profiles.

2. The system of claim 1, further comprising a communication subsystem configured to:
receive a query; and
in response to receiving the query:
provide one or more parameters to the analyzer subsystem, wherein at least some of the one or more parameters are determined based on the query;
receive data from the analyzer subsystem; and
provide the data received from the analyzer subsystem for output.

3. The system of claim 2, wherein the analyzer subsystem is further configured to:
identify, for each of multiple different geographical locations, a subset of employee profiles that each correspond to the geographical location and have a particular set of skills specified by the query;
determine, by analyzing each subset of the employee profiles, characteristics of a segment of the workforce having the particular set of skills for each of the different geographical locations; and
providing the determined characteristics to the communication subsystem;
wherein, to provide the data received from the analyzer subsystem for output, the communication subsystem is configured to provide, over a computer network for display at a client device, the information indicating the determined characteristics of the segment of the workforce having the particular set of skills for each of the different geographical locations.

4. The system of claim 1, wherein the aggregator subsystem is further configured to:
determine that the employee profiles do not include an employee profile corresponding to an employee related a particular resource included among the resources;
in response to the determination, generate a new employee profile corresponding to the employee; and
add, to the new employee profile, the attributes identified from the particular resource.

5. A computer-implemented method comprising:
accessing profile data comprising employee profiles that each correspond to a different employee, each employee profile including one or more attributes of the corresponding employee that were determined from publicly available Internet data describing the corresponding employee;
identifying, from a first profile of the employee profiles, a first attribute that is included in the first profile, the first profile corresponding to a particular employee;
selecting, from among the employee profiles, second profiles that each include the first attribute and correspond to an employee other than the particular employee;
identifying, from the second profiles, a second attribute that is included in at least some of the second profiles, wherein the second attribute is different from the first attribute and is not included in the first profile;
generating a confidence score for the second attribute based at least in part on a number of the second profiles that specify the second attribute;
determining that the confidence score for the second attribute satisfies a threshold; and
adding the second attribute to the first profile based at least on determining that the confidence score determined for the second attribute satisfies the threshold.

6. The computer-implemented method of claim 5, further comprising:
accessing a taxonomy of attributes that includes the first attribute;
determining that a third attribute is indicated as being related to the first attribute in the taxonomy, wherein the third attribute is different from the first attribute and is not included in the first profile; and
adding the third attribute to the first profile in response to determining that the third attribute is indicated as being related to the first attribute in the taxonomy.

7. The computer-implemented method of claim 6, wherein the taxonomy is a hierarchical taxonomy, and wherein determining that the third attribute is indicated as being related to the first attribute in the taxonomy comprises determining that the third attribute is inferior to the first attribute in the hierarchical taxonomy.

8. The computer-implemented method of claim 5, further comprising:
accessing, at a publicly available resource that is accessible over the Internet, information that (i) identifies one or more attributes included in the first profile, and that (ii) does not identify the particular employee;
identifying a third attribute included in the resource, wherein the third attribute is different from the first attribute and is not included in the first profile; and
adding the third attribute to the first profile.

9. The computer-implemented method of claim 5, wherein each of the employee profiles is assigned a robustness score, and wherein:
selecting the second profiles comprises selecting one or more profiles that include the first attribute and that are each assigned a robustness score that satisfies a second threshold.

10. The computer-implemented method of claim 5, further comprising:
selecting, after a period of time and from among the employee profiles, third profiles that each include the first attribute and correspond to an employee other than the particular employee;
identifying, from the third profiles, a third attribute that is included in at least some of the third profiles, wherein the third attribute is different from the first attribute and the second attribute and is not included in the first profile;
generating a confidence score for the third attribute based at least in part on a number of the third profiles that specify the third attribute;
determining that the confidence score for the third attribute satisfies a second threshold; and
adding the second attribute to the first profile based at least on determining that the confidence score determined for the third attribute satisfies the second threshold.

11. The computer-implemented method of claim 5, further comprising:
accessing synonym data indicates sets of attributes that are synonymous with one another, each set of attributes including one or more attributes that are synonymous with one another;
identifying, from the synonym data, a set of attributes that includes the first attribute;
identifying a third attribute that is included in the set of attributes that includes the first attribute, wherein the third attribute is different from the first attribute; and
adding the third attribute to the first profile.

12. The computer-implemented method of claim 5, wherein selecting the second profiles further comprises:
identifying a geographical area that is indicated by the first profile, wherein the geographical area corresponds to a work location or location of residence of the particular employee; and
identifying, as the second profiles, one or more profiles that each include the first attribute, correspond to an employee other than the particular employee, and indicate the geographical area.

13. The computer-implemented method of claim 5, wherein the confidence score for the second attribute is based at least in part on a proportion of the second profiles that specify the second attribute.

14. The computer-implemented method of claim 5, wherein the confidence score for the second attribute is based at least in part on one or more similarity measures, each of the one or more similarity measures indicating a degree of similarity between the first profile and a particular profile included in the second profiles.

15. A non-transitory computer-readable medium storing software comprising instructions executable by one or more computers which, upon such execution, cause the one or more computers to perform operations comprising:
accessing profile data comprising employee profiles that each correspond to a different employee, each employee profile including one or more attributes of the corresponding employee that were determined from publicly available Internet data describing the corresponding employee;
identifying, from a first profile of the employee profiles, a first attribute that is included in the first profile, the first profile corresponding to a particular employee;
selecting, from among the employee profiles, second profiles that each include the first attribute and correspond to an employee other than the particular employee;
identifying, from the second profiles, a second attribute that is included in at least some of the second profiles, wherein the second attribute is different from the first attribute and is not included in the first profile;
generating a confidence score for the second attribute based at least in part on a number of the second profiles that specify the second attribute;
determining that the confidence score for the second attribute satisfies a threshold; and
adding the second attribute to the first profile based at least on determining that the confidence score determined for the second attribute satisfies the threshold.

16. The non-transitory computer-readable medium of claim 15, wherein the operations further comprise:
accessing a taxonomy of attributes that includes the first attribute;
determining that a third attribute is indicated as being related to the first attribute in the taxonomy, wherein the third attribute is different from the first attribute and is not included in the first profile; and
adding the third attribute to the first profile in response to determining that the third attribute is indicated as being related to the first attribute in the taxonomy.

17. The non-transitory computer-readable medium of claim 16, wherein the taxonomy is a hierarchical taxonomy, and wherein determining that the third attribute is indicated as being related to the first attribute in the taxonomy comprises determining that the third attribute is inferior to the first attribute in the hierarchical taxonomy.

18. The non-transitory computer-readable medium of claim 15, wherein the operations further comprise:
accessing, at a publicly available resource that is accessible over the Internet, information that (i) identifies one or more attributes included in the first profile, and that (ii) does not identify the particular employee;
identifying a third attribute included in the resource, wherein the third attribute is different from the first attribute and is not included in the first profile; and
adding the third attribute to the first profile.

19. The non-transitory computer-readable medium of claim 15, wherein the operations further comprise:
accessing synonym data indicates sets of attributes that are synonymous with one another, each set of attributes including one or more attributes that are synonymous with one another;
identifying, from the synonym data, a set of attributes that includes the first attribute;
identifying a third attribute that is included in the set of attributes that includes the first attribute, wherein the third attribute is different from the first attribute; and
adding the third attribute to the first profile.

20. The non-transitory computer-readable medium of claim 15, wherein the confidence score for the second attribute is based at least in part on a proportion of the second profiles that specify the second attribute.
